(19) United States
(12) Patent Application Publication
(10) Pub. No.: US 2025/0393047 A1
(43) Pub. Date: Dec. 25, 2025

(54) CONTENTION-BASED UPLINK TRANSMISSION

(71) Applicant: Lenovo (United States) Inc., Morrisville, NC (US)

(72) Inventors: Joachim Löhr, Wiesbaden (DE); Alexander Golitschek Edler von Elbwart, Darmstadt (DE); Prateek Basu Mallick, Dreieich (DE); Hyejung Jung, Northbrook, IL (US); Karthikeyan Ganesan, Nauheim (DE); Ravi Kuchibhotla, Chicago, IL (US)

(21) Appl. No.: 19/308,025

(22) Filed: Aug. 22, 2025

(51) Int. Cl. H04W 72/21; H04L 1/00; H04L 1/1812

(52) U.S. Cl. CPC H04W 72/21; H04L 1/0003; H04L 1/1812

(57) ABSTRACT

Various aspects of the present disclosure relate to receiving a resource allocation comprising a plurality of sets of uplink resources for contention-based uplink transmission; and performing a contention-based uplink transmission on one of the plurality of sets of uplink resources based at least in part on a condition for the contention-based uplink transmission being satisfied, where the contention-based uplink transmission comprises a first uplink signal and a second uplink signal transmitted in a same time resource.

### TECHNICAL FIELD

The present disclosure relates to wireless communications, and more specifically to techniques for performing a contention-based uplink transmission on a set of uplink resources.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G) radio access technology, etc.).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to receive a resource allocation comprising a plurality of sets of uplink resources for contention-based uplink transmission; and perform a contention-based uplink transmission on one of the plurality of sets of uplink resources based at least in part on a condition for the contention-based uplink transmission being satisfied, wherein the contention-based uplink transmission comprises a first uplink signal and a second uplink signal transmitted on a same time resource.

A processor for wireless communication is described. The processor may be configured to, capable of, or operable to receive a resource allocation comprising a plurality of sets of uplink resources for contention-based uplink transmission; and perform a contention-based uplink transmission on one of the plurality of sets of uplink resources based at least in part on a condition for the contention-based uplink transmission being satisfied, wherein the contention-based uplink transmission comprises a first uplink signal and a second uplink signal transmitted on a same time resource.

A method performed or performable by a UE is described. The method may include receiving a resource allocation comprising a plurality of sets of uplink resources for contention-based uplink transmission; and performing a contention-based uplink transmission on one of the plurality of sets of uplink resources based at least in part on a condition for the contention-based uplink transmission being satisfied, wherein the contention-based uplink transmission comprises a first uplink signal and a second uplink signal transmitted on a same time resource.

A base station for wireless communication is described. The base station may be configured to, capable of, or operable to transmit a resource allocation comprising a plurality of sets of uplink resources for contention-based uplink transmission; receive a contention-based uplink transmission on one of the plurality of sets of uplink resources, wherein the contention-based uplink transmission comprises a first uplink signal and a second uplink signal received in a same time resource; and transmit a feedback based on whether the second uplink signal of the contention-based uplink transmission is successfully decoded.

A processor for wireless communication is described. The processor may be configured to, capable of, or operable to transmit a resource allocation comprising a plurality of sets of uplink resources for contention-based uplink transmission; receive a contention-based uplink transmission on one of the plurality of sets of uplink resources, wherein the contention-based uplink transmission comprises a first uplink signal and a second uplink signal received in a same time resource; and transmit a feedback based on whether the second uplink signal of the contention-based uplink transmission is successfully decoded.

A method performed or performable by a base station is described. The method may include transmitting a resource allocation comprising a plurality of sets of uplink resources for contention-based uplink transmission; receiving a contention-based uplink transmission on one of the plurality of sets of uplink resources, wherein the contention-based uplink transmission comprises a first uplink signal and a second uplink signal received in a same time resource; and transmitting a feedback based on whether the second uplink signal of the contention-based uplink transmission is successfully decoded.

### BRIEF DESCRIPTION OF THE DRAWINGS

FIG. 1 illustrates an example of a wireless communications system in accordance with aspects of the present disclosure.

FIG. 2 illustrates an example of a procedure for contention-based uplink transmission on a set of uplink resources, in accordance with aspects of the present disclosure.

FIG. 3 illustrates an example of a set of uplink resources for contention-based uplink transmission, in accordance with aspects of the present disclosure.

FIG. 4 illustrates an example of another procedure for contention-based uplink transmission on a set of uplink resources, in accordance with aspects of the present disclosure.

FIG. 5 illustrates an example of another set of uplink resources for contention-based uplink transmission, in accordance with aspects of the present disclosure.

FIG. 6 illustrates an example of a protocol stack, in accordance with aspects of the present disclosure.

FIG. 7 illustrates an example of a UE, in accordance with aspects of the present disclosure.

FIG. 8 illustrates an example of a processor, in accordance with aspects of the present disclosure.

FIG. 9 illustrates an example of a NE, in accordance with aspects of the present disclosure.

FIG. 10 illustrates a flowchart of a method performed by a UE in accordance with aspects of the present disclosure.

FIG. 11 illustrates a flowchart of a method performed by a NE in accordance with aspects of the present disclosure.

### DETAILED DESCRIPTION

A wireless communication network, including one or more wireless devices, nodes, network entities, etc., may support configured uplink grants, referring to semi-statically allocation of uplink resources, e.g., for periodic and predictable uplink traffic. For example, in 5G New Radio (NR), a configured uplink grant may be used for user data transmission such as UE status reporting (e.g., buffer status reporting (BSR) and/or delay status reporting (DSR)), when the UE is in a radio resource control (RRC) connected state, or small data transmission (SDT) when the UE is in an RRC inactive state. Additionally, configured uplink grant may be used for random access channel (RACH)-less lower-layer triggered mobility (LTM) cell switch, and RACH-less handover.

In some implementations, configured grant (CG) uplink resources may be suitable for periodic uplink traffic in ultra-reliable and low-latency communication (URLLC) services. In some implementations, CG uplink resources may be beneficial for UE power saving with reduced physical downlink channel (PDCCH) monitoring and a capacity increase with multiple transmission occasions per period in extended reality (XR) services.

In some examples, a network entity, such as a next-generation Node B (gNB) may allocate uplink resources of configured grants to a UE for an initial hybrid automatic repeat request (HARQ) transmission and HARQ retransmissions. With Type 1 configured grant, RRC signaling is used directly to provide a configured uplink grant, including a periodicity with semi-static resource allocation. With Type 2 configured grant, RRC signaling is used to define a periodicity of a configured uplink grant, and control signaling (e.g., a PDCCH transmission) addressed to a configured scheduling radio network temporary identifier (CS-RNTI) may be used either to signal and activate the configured uplink grant or to deactivates it, which provides semi-persistent uplink-shared channel (UL-SCH) resources. While the configured uplink grant feature in 5G NR is beneficial for various vertical services, both Type 1 and Type 2 CGs are controlled and initiated by a network and accordingly, may not efficiently support less predictable mobile originated (MO) traffics.

In addition to configured uplink grants, a wireless communication network may support dynamic grants of uplink resources, such as for sporadic or unpredictable traffic. For example, in 5G NR systems, a UE having data available may transmit a request for resources (e.g., a scheduling request (SR) or a buffer status report (BSR)). Upon receiving the request, the network (e.g., gNB) dynamically schedules uplink resources, e.g., by transmitting a downlink control information (DCI) that indicates the allocation of uplink resources. However, the dynamic uplink resource allocation process inherently incurs latency due to the sequential transmission of SRs and BSRs. For example, upon the arrival of new, high-priority uplink data at the UE, the UE must first transmit an SR to request uplink resources. In response, the network (e.g., base station, gNB) allocates a limited initial uplink grant to enable the UE to transmit a BSR, which informs the scheduler about the volume, and to some extent the nature, of data awaiting transmission. This multi-step signaling procedure introduces scheduling delays that may be incompatible with latency-critical applications.

Although configured uplink grants offer a mechanism to bypass this delay by pre-allocating periodic resources to the UE, such an approach is inefficient in terms of spectral usage, particularly when the uplink traffic is sporadic or bursty. Given that wireless communication systems supporting radio access technologies beyond 5G (e.g., 6G) are expected to support significantly more demanding latency and reliability requirements than 5G were designed to handle, there is a need to reduce uplink scheduling latency. Specifically, improvements are needed to enable faster access to uplink resources, particularly for delay-sensitive traffic, without incurring the inefficiencies associated with persistent dedicated resource reservation.

The present disclosure describes procedures for enabling contention-based uplink access as an alternative to conventional grant-based uplink scheduling. In various implementations, the procedures described herein significantly reduce end-to-end latency by eliminating the delay of a multi-step uplink scheduling procedure.

In some implementations, a UE eligible for contention-based transmission may autonomously initiate uplink data transmission without awaiting explicit allocation (i.e., dynamic grant) of uplink resources from the network. Beneficially, this contention-based uplink access scheme eliminates the scheduling delay typically associated with the SR/BSR procedure, thereby improving responsiveness for latency-sensitive services.

Multiple implementations of contention-based uplink access are described, offering varying degrees of configurability and network control over uplink transmission parameters.

In some implementations, a UE may initiate a contention-based uplink transmission by transmitting a preamble along with an associated uplink data transmission on a contention-based physical uplink shared channel (CB-PUSCH) within the same slot. The preamble may be autonomously selected by the UE based on predetermined selection rules or criteria, e.g., from a predefined set of available preambles. In certain implementations, the CB-PUSCH may contain an identifier (ID) field (e.g., in a medium access control control element (MAC-CE)) that identifies the UE associated with the contention-based uplink transmission. In one example, a cell radio network temporary identifier (C-RNTI) MAC-CE is multiplexed in the CB-PUSCH transmission.

In some implementations, the network (e.g., a gNB or other network entity) may configure whether a logical channel (LCH) is eligible for a CB-PUSCH transmission. For example, a new logical channel restriction may be introduced which controls whether data of a LCH is allowed to be sent on contention-based uplink resources. In certain implementations, the network configuration enables the network (e.g., gNB) scheduler to ensure that quality-of-service (QoS) requirements of LCHs are satisfied, such as LCH carrying data with strict QoS requirements may not be suitable for a contention-based uplink transmission and should instead be transmitted on dedicated uplink resources. Similarly, the network may also configure whether a MAC-CE is eligible for contention-based uplink transmissions.

In some implementations, a new type of uplink grant may be introduced to facilitate contention-based uplink transmissions, with the objective of reducing the overall latency associated with the conventional uplink scheduling procedures. In certain implementations, a UE which is eligible for contention-based uplink transmission may autonomously select one or more uplink transmission parameters associated with a CB-PUSCH transmission. For example, the parameters may include a modulation and coding scheme (MCS) parameter, resource block (RB) allocation size and location parameters, a redundancy version (RV) parameter, or a combination thereof. In order to reduce the blind decoding complexity at the network side and to ensure successful decoding of the CB-PUSCH transmission, the UE may transmit associated uplink control information (UCI) to the network (e.g., gNB). In certain implementations, the UCI may be transmitted via an out-of-band signaling mechanism.

While presented as distinct solutions, one or more of the solutions described herein may be implemented in combination with each other. Aspects of the present disclosure are described in the context of a wireless communications system.

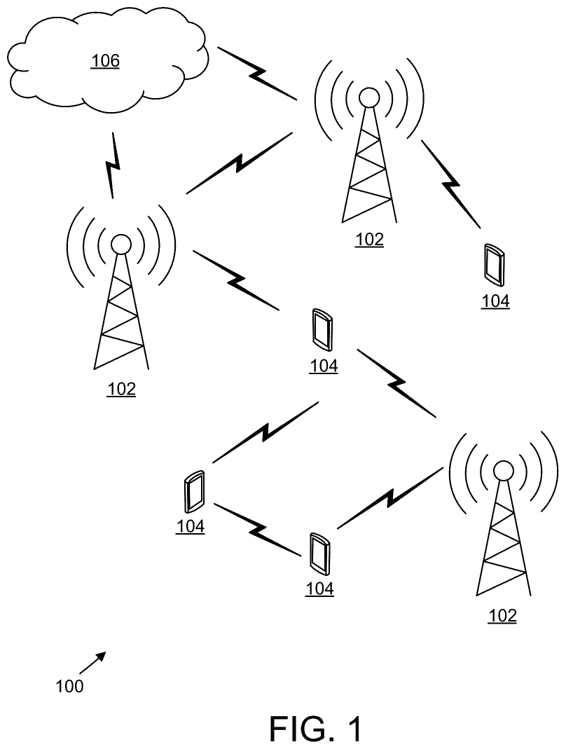

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies (RATs). In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In some other implementations, the wireless communications system 100 may be a 6G radio (6GR) network, such as a 6G network. In other implementations, the wireless communications system 100 may be a combination of a 4G network and/or a 5G network and/or a 6G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6GR. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a RAN node, a NodeB, an eNodeB (eNB), a gNB, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3,μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHz), frequency range #2 (FR2) (e.g., 24.25 GHz-52.6 GHz), frequency range #3 (FR3) (e.g., 7.125 GHz-24.25 GHz), frequency range #4 (FR4) (e.g., 52.6 GHz-114.25 GHz), frequency range #4a (FR4a) or frequency range #4-1 (FR4-1) (e.g., 52.6 GHz-71 GHz), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

According to implementations, one or more of the NEs 102 and the UEs 104 are operable to implement various aspects of the techniques described with reference to the present disclosure.

In some implementations, an NE 102 may transmit, and a UE 104 may receive, a resource allocation that includes multiple sets of uplink resources for contention-based uplink transmissions. For example, the NE 102 may transmit a configuration message that includes multiple uplink resource assignments for one or more contention-based uplink transmissions.

In some implementations, the UE 104 may determine that a condition is satisfied for a contention-based uplink transmission. For example, the NE 102 may transmit, and the UE 104 may receive, a LCH configuration that indicates which of a plurality of LCHs are eligible for the contention-based uplink transmissions. Thereafter, the UE 104 may determine that data is available for transmission (e.g., in a buffer of the UE 104), where the available data belongs to one or more LCHs that are eligible for the contention-based uplink transmissions.

In some implementations, the UE 104 may perform a contention-based uplink transmission on a set of the uplink resources, i.e., based at least in part on the condition for the contention-based uplink transmission being satisfied. In various implementations, the contention-based uplink transmission includes a first uplink signal and a second uplink signal transmitted on the same time resource (e.g., within the same slot).

In one example, the first uplink signal is a preamble, e.g., comprising a sequence that is mapped to a particular set of time and frequency resources (e.g., transmission occasion) for an associated uplink data transmission (i.e., the second uplink signal) and thus identifies the second uplink signal. In another example, the first uplink signal includes an UCI that is mapped to a particular set of time and frequency resources (e.g., transmission occasion) for an associated uplink data transmission (i.e., the second uplink signal) and that indicates one or more transmission parameters for the uplink data transmission.

In certain implementations, the NE 102 transmits feedback to the UE 104 in response to detecting the contention-based uplink transmission, the feedback based on whether the second uplink signal was successfully decoded. For example, the NE 102 may transmit a feedback message that indicates successful reception of the second uplink signal (e.g., the uplink data) or includes an uplink grant for retransmission of the second uplink signal. In certain implementations, the UE 104 monitor for feedback in response to the contention-based uplink transmission and may re-transmit the contention-based uplink transmission when the feedback is not received during a predefined time window.

Regarding buffer status reporting, in 3GPP 5G NR, a buffer status reporting procedure is used for a UE 104 to provide a serving NE 102 (e.g., gNB) with information about uplink data volume in a medium access control (MAC) entity of the UE 104. In some embodiments, the NE 102 (e.g., gNB) may use RRC signaling to configure the UE 104 with one or more of the following parameters to control the BSR: A) periodicBSR-Timer; B) retxBSR-Timer; C) logicalChannelSR-DelayTimerApplied; D) logicalChannelSR-DelayTimer; E) logicalChannelSR-Mask; F) logicalChannelGroup; G) logicalChannelGroupIAB-Ext; H) sdt-LogicalChannelSR-DelayTimer; I) additionalBS-TableAllowed; or a combination thereof.

In some implementations, each LCH may be allocated to a logical channel group (LCG) using the parameter logicalChannelGroup. The maximum number of LCGs is eight except for IAB-MTs configured with logicalChannelGroupIAB-Ext, for which the maximum number of LCGs is 256.

In some implementations, a MAC entity of the UE 104 may determine the amount of uplink data available for a LCH according to the data volume calculation procedure, for example, as described in 3GPP technical specification (TS) 38.322 and TS 38.323.

In some implementations, the UE 104 may trigger a BSR if any of the following events occur for activated cell group: A) uplink data, for a LCH which belongs to an LCG, becomes available to the MAC entity of the UE 104; and either 1) this uplink data belongs to a LCH with higher priority than the priority of any LCH containing available uplink data which belong to any LCG; or 2) none of the LCHs which belong to an LCG contains any available uplink data (in which case the BSR is referred below to as ‘Regular BSR’); B) uplink resources are allocated and number of padding bits is equal to or larger than the size of the BSR MAC-CE, plus its subheader, in which case the BSR is referred below to as ‘Padding BSR’; C) retxBSR-Timer expires, and at least one of the LCHs which belong to an LCG contains uplink data, in which case the BSR is referred below to as ‘Regular BSR’; or D) periodicBSR-Timer expires, in which case the BSR is referred below to as ‘Periodic BSR’.

In some implementations, when Regular BSR triggering events occur for multiple LCHs simultaneously, each LCH triggers one separate Regular BSR. If a HARQ process is configured with cg-RetransmissionTimer and if the BSR is already included in a MAC PDU for transmission on configured grant by this HARQ process, but not yet transmitted by lower layers, it is up to the UE 104 implementation how to handle the BSR content.

In certain implementations, for BSR triggered by retxBSR-Timer expiry, the MAC entity of the UE 104 may consider that the LCH that triggered the BSR is the highest priority LCH that has data available for transmission at the time the BSR is triggered. A MAC PDU shall contain at most one BSR MAC-CE, even when multiple events have triggered a BSR. The Regular BSR and the Periodic BSR shall have precedence over the padding BSR.

In some implementations, UL-SCH resources are considered available if the MAC entity of the UE 104 has an active configured grant, or receives, or determines an uplink grant. If the MAC entity has determined at a given point in time that UL-SCH resources are available, this need not imply that UL-SCH resources are available for use at that point in time. The MAC entity restarts the retxBSR-Timer upon reception of a grant for transmission of new data on any UL-SCH.

In some implementations, all triggered BSRs may be cancelled when the uplink (UL) grant(s) can accommodate all pending data available for transmission but is not sufficient to additionally accommodate the BSR MAC-CE plus its subheader. In some implementations, all BSRs triggered prior to MAC PDU assembly shall be cancelled when a MAC PDU is transmitted and this PDU includes a Long, Refined Long, Extended Long, Short, or Extended Short BSR MAC-CE which contains buffer status up to (and including) the last event that triggered a BSR prior to the MAC PDU assembly.

In certain implementations, MAC PDU assembly may happen at any point in time between uplink grant reception and actual transmission of the corresponding MAC PDU. BSR and SR can be triggered after the assembly of a MAC PDU which contains a BSR MAC-CE, but before the transmission of this MAC PDU. In addition, BSR and SR can be triggered during MAC PDU assembly.

In some implementations, all pending SR(s) for BSR triggered prior to the MAC PDU assembly may be cancelled and each respective sr-ProhibitTimer may be stopped when the MAC PDU is transmitted and this PDU includes a Long, Refined Long or Short BSR MAC-CE which contains buffer status up to (and including) the last event that triggered a BSR prior to the MAC PDU assembly. In some implementations, all pending SR(s) for BSR triggered may be cancelled and each respective sr-ProhibitTimer shall be stopped when the UL grant(s) can accommodate all pending data available for transmission.

Regarding delay status reporting, in 3GPP 5G NR, a delay status reporting procedure may be used to provide a serving NE 102 (e.g., gNB) with delay status of LCGs. This delay status for an LCG includes remaining time, which is the smallest remaining value of the running packet data convergence protocol (PDCP) discardTimers among PDCP service data units (SDUs) that are buffered for the LCG but have not been transmitted in any MAC PDU, and the total amount of delay-critical uplink data for the LCG.

In some implementations, the NE 102 (e.g., gNB) may use RRC signaling to configure the UE 104 with one or more of the following parameters to control the DSR procedure by configuring the parameter remaining TimeThreshold (per LCG), which configures the threshold on remaining time for triggering a DSR for a logical channel within an LCG.

If an LCG is configured for delay status reporting, for each logical channel within the LCG: if the smallest remaining value of the running PDCP discardTimers among all the PDCP SDUs buffered for the logical channel that have not been transmitted in any MAC PDU and have not been reported as data volume in a DSR MAC-CE becomes below remaining Time Threshold of the LCG; and if there is no DSR pending for the logical channel, then the MAC entity of the UE 104 triggers a DSR for the logical channel.

Regarding the configured uplink grant, in 5G NR, there are two types of transmission without dynamic grant: A) configured grant Type 1 where an uplink grant is provided by RRC, and stored as configured uplink grant; and B) configured grant Type 2 where an uplink grant is provided by PDCCH, and stored or cleared as configured uplink grant based on layer 1 (L1) signaling indicating configured uplink grant activation or deactivation.

In some implementations, the Type 1 and Type 2 CGs may be configured by RRC signaling for a serving cell per bandwidth part (BWP). Multiple configurations may be active simultaneously in the same BWP. For Type 2 CGs, activation and deactivation are independent among the serving cells. For the same BWP, the MAC entity of the UE 104 can be configured with both Type 1 and Type 2 CGs.

A multi-physical uplink shared channel (multi-PUSCH) configured grant has multiple consecutive configured uplink grants within a periodicity. Both Type 1 and Type 2 CGs can be configured for a multi-PUSCH configured grant by RRC signaling.

Only a Type 1 CG can be configured for CG-SDT or for RACH-less LTM cell switch or for RACH-less handover. CG-SDT can only be configured on initial BWP.

In some implementations, the network may use RRC signaling to configure the UE 104 with the one or more following parameters when the Type 1 CG is configured: A) cs-RNTI (e.g., the CS-RNTI for retransmission); B) cg-SDT-CS-RNTI (e.g., the CS-RNTI for CG-SDT retransmission); C) cg-SDT-RSRP-ThresholdSSB (e.g., an RSRP threshold configured for synchronization signal block (SSB) selection for CG-SDT; D) cg-RRC-RSRP-ThresholdSSB (e.g., an RSRP threshold configured for SSB selection for RACH-less handover); E) periodicity (e.g., the periodicity of the Type 1 CG); F) timeDomainOffset (e.g., the offset of a resource with respect to system frame number (SFN)=timeReferenceSFN in time domain); G) timeDomainAllocation (e.g., an allocation of configured uplink grant in time domain which contains startSymbolAndLength (i.e., the start and length indicator value (SLIV) in TS 38.214) or startSymbol (i.e., S in TS 38.214); H) nrofHARQ-Processes (e.g., the number of HARQ processes for the CG; I) harq-ProcID-Offset (e.g., the offset of HARQ process for configured grant configured with cg-RetransmissionTimer for operation with shared spectrum channel access; J) harq-ProcID-Offset2 (e.g., the offset of HARQ process for configured grant not configured with cg-RetransmissionTimer); K) timeReferenceSFN (e.g., the SFN used for determination of the offset of a resource in time domain; the UE 104 uses the closest SFN with the indicated number preceding the reception of the configured grant configuration); L) timeReferenceHyperSFN (e.g., the hyper SFN (H-SFN) used for determination of the offset of a resource in time domain; the UE 104 uses the closest H-SFN with the indicated number preceding the reception of the configured grant configuration); or a combination thereof.

In some implementations, the network may use RRC signaling to configure the UE 104 with the one or more following parameters when the Type 2 CG is configured: A) cs-RNTI (e.g., the CS-RNTI for activation, deactivation, and retransmission); B) periodicity (e.g., the periodicity of the Type 2 CG); C) nrofHARQ-Processes (the number of HARQ processes for the Type 2 CG); D) harq-ProcID-Offset (e.g., the offset of HARQ process for the CG configured with cg-RetransmissionTimer for operation with shared spectrum channel access); E) harq-ProcID-Offset2 (e.g., the offset of HARQ process for configured grant not configured with cg-RetransmissionTimer); or a combination thereof.

In some implementations, the network may use RRC signaling to configure the UE 104 with the one or more following parameters when retransmissions on configured uplink grant is configured: A) cg-RetransmissionTimer (e.g., the duration after a configured grant (re)transmission of a HARQ process when the UE 104 shall not autonomously retransmit that HARQ process); B) cg-SDT-RetransmissionTimer (e.g., the duration after a configured grant (re)transmission of a HARQ process of the initial CG-SDT transmission with CCCH message when the UE 104 shall not autonomously retransmit the HARQ process); C) cg-RRC-RetransmissionTimer (e.g., the duration after a configured grant (re)transmission of a HARQ process of the initial transmission of RACH-less handover and RACH-less LTM cell switch when the UE 104 shall not autonomously retransmit the HARQ process); or a combination thereof.

In some implementations, the network may use RRC signaling to configure the UE 104 with the following parameter when a multi-PUSCH configured grant is configured: nrofSlotsInCG-Period (e.g., the number of configured uplink grants in a periodicity of a multi-PUSCH configured grant).

In some implementations, the network may use RRC signaling to configure the UE 104 with the following parameter when unused transmission occasion-uplink control information (UTO-UCI) is configured for a configured grant: nrofBitsInUTO-UCI (e.g., number of bits in a UTO-UCI bitmap).

In certain implementations, for a configured uplink grant, if its associated configured grant is configured with UTO-UCI and it has not been indicated to the lower layers as unused for physical uplink shared channel (PUSCH) transmission, then the MAC entity of the UE 104 considers it available for use.

In certain implementations, for a configured uplink grant, if its associated configured grant is not configured with UTO-UCI and either if it is associated with a multi-PUSCH configured grant and meets the validity conditions specified in the clause 6.1 in TS 38.214 or if it is not associated with a multi-PUSCH configured grant, then the MAC entity of the UE 104 considers it available for use. In some implementations, the MAC entity does not include the UL-SCH resource of a configured uplink grant not available for use in its procedures.

For a configured grant configured with UTO-UCI, the MAC entity of the UE 104 determines if a configured uplink grant which is within the subsequent nrofBitsInUTO-UCI valid occasions of its associated configured grant configuration is going to be used for PUSCH transmission by considering at least the amount of buffered data that can be transmitted on the available occasions of the associated configured grant and other available UL-SCH resources. Upon this determination, the MAC entity sends an indication to lower layers, for use in the procedure for reporting UTO-UCI.

Upon configuration of a configured grant Type 1 for a BWP of a Serving Cell by upper layers, the MAC entity of the UE 104 stores the uplink grant provided by upper layers as a configured uplink grant for the indicated BWP of the Serving Cell. If the parameter cg-SDT-PeriodicityExt is configured, then the MAC entity may initialize or re-initialize the configured uplink grant to start in the symbol according to time DomainOffset, time ReferenceHyperSFN, time ReferenceSFN, and S (derived from SLIV or provided by startSymbol as specified in TS 38.214), and to reoccur with cg-SDT-PeriodicityExt. Otherwise, the MAC entity may initialize or re-initialize the configured uplink grant to start in the symbol according to timeDomainOffset, timeReferenceSFN, and S (derived from SLIV or provided by startSymbol as specified in TS 38.214), and to reoccur with periodicity.

If cg-SDT-PeriodicityExt is not configured, after an uplink grant is configured for a configured grant Type 1, the MAC entity of the UE 104 considers sequentially that the configured uplink grant, or the first configured uplink grant in a multi-PUSCH configured grant, in the Nth (N≥0) periodicity occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) modulo ( 1024 \times numberOfSlotsPerFrame \times numberOfSymbolsPerSlot )$$

If cg-SDT-PeriodicityExt is configured, after an uplink grant is configured for a configured grant Type 1, the MAC entity of the UE 104 considers sequentially that the configured uplink grant in the N^{th} (N≥0) periodicity occurs in the symbol for which:

$$[ ( H - SFN \times numberOfSFNperH - SFN + SFN ) \times numberOfSlotsPerFrame \times numberOfSymbolsPerSlot + ( slot number in the frame \times numberOfSymbolsPerSlot ) + symbol number in the slot ] = ( ( timeReferenceHyperSFN \times numberOfSFNperH - SFN + timeReferenceSFN ) \times numberOfSlotsPerFrame \times numberOfSymbolsPerSlot + timeDomainOffset \times numberOfSymbolsPerSlot + S + N \times cg - SDT - PeriodicityExt ) modulo ( 1024 \times 1024 \times numberOfSlotsPerFrame \times numberOfSymbolsPerSlot )$$

For a multi-PUSCH configured grant Type 1, the M^{th} (1<M≤nrofSlotsInCG-Period) configured uplink grant within a periodicity occurs (M-1) × numberOfSymbolsPerSlot symbols after the symbol in which the first configured uplink grant in that periodicity occurs.

After an uplink grant is configured for a configured grant Type 2, the MAC entity of the UE 104 considers sequentially that the configured uplink grant, or the first configured uplink grant in a multi-PUSCH configured grant, in the Nth (N ≥ 0) periodicity occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = [ ( {SFN}_{start time} \times numberOfSlotsPerFrame \times numberOfSymbolsPerSlot + {slot}_{start time} \times numberOfSymbolsPerSlot + {symbol}_{start time} ) + N \times periodicity ] modulo ( 1024 \times numberOfSlotsPerFrame \times numberOfSymbolsPerSlot )$$

where SFNstart time, slotstart time, and symbolstart time are the SFN, slot, and symbol, respectively, of the first transmission opportunity of PUSCH where the configured uplink grant was initialized (or re-initialized).

For a multi-PUSCH configured grant Type 2, the M^{th} (1<M≤nrofSlotsInCG-Period) configured uplink grant within the same periodicity occurs (M−1)×numberOfSymbolsPerSlot symbols after the symbol in which the first configured uplink grant in that periodicity occurs. If cg-nrofPUSCH-InSlot or cg-nrofSlots is configured for a configured grant Type 1 or Type 2, the MAC entity of the UE 104 considers the uplink grants to occur in those additional PUSCH allocations, e.g., as specified in clause 6.1.2.3 of TS 38.214.

In certain implementations, in case of unaligned SFN across carriers in a cell group, the SFN of the concerned Serving Cell is used to calculate the occurrences of configured uplink grants. When the configured uplink grant is released by upper layers, all the corresponding configurations shall be released and all corresponding uplink grants shall be cleared.

In certain implementations, for a configured grant Type 2, the MAC entity of the UE 104 clears the configured uplink grant(s) immediately after first transmission of Configured Grant Confirmation MAC-CE or Multiple Entry Configured Grant Confirmation MAC-CE which confirms the configured uplink grant deactivation.

In some implementations, retransmissions use: A) repetition of configured uplink grants; or B) received uplink grants addressed to CS-RNTI; or C) configured uplink grants with cg-RetransmissionTimer, cg-RRC-RetransmissionTimer, or cg-SDT-RetransmissionTimer configured.

When URLLC services deployed in shared spectrum, for potential listen-before-talk (LBT) failures on configured uplink grants, a CG retransmission timer can be optionally configured to enable autonomous retransmissions, and it may be configured simultaneously with enhanced intra-UE overlapping resource prioritization mechanisms. When the CG retransmission timer is configured, the UE 104 selects a HARQ process for each CG resource by itself. If the enhanced intra-UE overlapping resource prioritization mechanisms is also configured, the UE 104 may be further configured to select a HARQ process for a CG resource based on logical channel priority.

Regarding UE procedures for reporting UTO-UCI, if the UE 104 is provided nrofBitsInUTO-UCI with value equal to O^{UTO-UCI} in configuredGrantConfig of a CG-PUSCH configuration, the UE 104 multiplexes UTO-UCI represented by a bitmap of O^{UTO-UCI} bits in each CG-PUSCH transmission for the CG-PUSCH configuration. The O^{UTO-UCI} bits of UTO-UCI,

$${\tilde{o}}_{0}^{UTO - UCI} , {\tilde{o}}_{1}^{UTO - UCI} , … , {\tilde{o}}_{{o}^{UTO - UCI} - 1}^{UTO - UCI} ,$$

have a one-to-one mapping to O^{UTO-UCI} subsequent CG-PUSCH TOs of the CG-PUSCH configuration in ascending order of start time. For unpaired spectrum operation, the O^{UTO-UCI} subsequent CG-PUSCH TOs exclude invalid ones where the UE 104 does not transmit a PUSCH due to collision of the PUSCH with downlink (DL) symbol(s) indicated by tdd-UL-DL-ConfigurationCommon or tdd-UL-DL-ConfigurationDedicated if provided, or with symbol(s) of an SS/PBCH block with index provided by ssb-PositionsInBurst. A bit value of ‘0’ indicates that the UE 104 may transmit CG-PUSCH, and a bit value of ‘1’ indicates that the UE 104 will not transmit CG-PUSCH, in a corresponding CG-PUSCH transmission occasion (TO). When the UE 104 indicates by UTO-UCI a value of ‘1’ for a CG-PUSCH TO, the UE 104 continues to indicate the value of ‘1’ for the CG-PUSCH TO by UTO-UCI multiplexed in subsequent CG-PUSCH transmissions, and the UE 104 does not transmit CG-PUSCH in the CG-PUSCH TO.

Regarding LCH prioritization (LCP) restrictions in MAC, the network may use RRC signaling to configure the UE 104 to restrict mapping of a LCH to a subset of configured cells, numerologies, PUSCH transmission durations, configured grant configurations and control whether a LCH can utilize the resources allocated by a Type 1 configured grant or whether a LCH can utilize dynamic grants indicating a certain physical priority level. With such restrictions, it then becomes possible to reserve, for instance, the numerology with the largest subcarrier spacing and/or shortest PUSCH transmission duration for URLLC services. Furthermore, RRC can associate LCHs with different SR configurations, for instance, to provide more frequent SR opportunities to URLLC services.

In some implementations, if a UE 104 is not configured with enhanced intra-UE overlapping resources prioritization, a dynamically allocated uplink transmission overrides a configured uplink grant in the same serving cell, if they overlap in time. Otherwise, an uplink transmission according to the configured uplink grant is assumed, if activated.

If a UE 104 is configured with enhanced intra-UE overlapping resources prioritization, in case a configured uplink grant transmission overlaps in time with a dynamically allocated uplink transmission or with another configured uplink grant transmission in the same serving cell, then the UE 104 may prioritize the transmission based on the comparison between the highest priority of LCHs that have data to be transmitted and which are multiplexed or can be multiplexed in MAC PDUs associated with the overlapping resources.

Similarly, in case a configured uplink grant transmissions or a dynamically allocated uplink transmission overlaps in time with a SR transmission, the UE 104 may prioritize the transmission based on the comparison between a priority of a LCH which triggered the SR and the highest priority of LCHs that have data to be transmitted and which are multiplexed or can be multiplexed in MAC PDU associated with the overlapping resource. In case the MAC PDU associated with a deprioritized transmission has already been generated, the UE 104 may keep it stored to allow the NE 102 (e.g., gNB) to schedule a retransmission. The UE 104 may also be configured by the NE 102 to transmit the stored MAC PDU as a new transmission using a subsequent resource of the same configured uplink grant configuration when an explicit retransmission grant is not provided by the NE 102.

According to aspects of a first solution, a UE 104 may initiate a contention-based uplink transmission by transmitting a preamble on a physical random access channel (PRACH) along with an associated uplink data transmission on a CB-PUSCH within the same slot. In some implementations, the UE 104 may perform the contention-based uplink transmission, for example, via frequency division multiplexing (FDM) between the preamble and the CB-PUSCH within the slot.

In some examples, the preamble may be autonomously selected by the UE 104 from a predefined pool of available preambles, e.g., based on predetermined selection rules or criteria. The primary purpose of the preamble transmission is to enable a NE 102 (e.g., base station, gNB) to detect a contention-based uplink transmission by the UE 104.

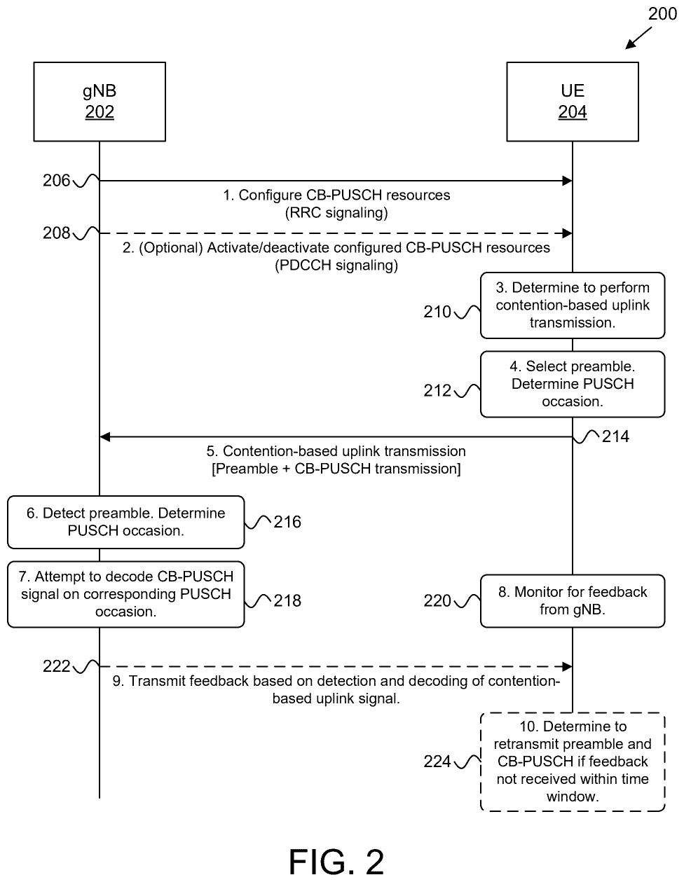

FIG. 2 illustrates an example of a procedure 200 for contention-based uplink transmission on a set of uplink resources, in accordance with aspects of the present disclosure. The procedure 200 may implement or be implemented by aspects of the wireless communication system 100. For example, the procedure 200 may include a gNB 202 and at least one UE 204. The gNB 202 may implement or be implemented by an NE 102, and the UE(s) 204 may implement or be implemented by one or more UEs 104 as described herein.

At Step 1, the gNB 202 configures the one or more UEs 204 with CB-PUSCH resources, e.g., by sending a configuration message for contention-based uplink transmission (see messaging 206). In some implementations, the configuration message may be conveyed using RRC signaling.

In certain implementations, the CB-PUSCH resources are automatically activated upon configuration, e.g., the configuration message defines a semi-static allocation of uplink resources for contention-based uplink transmission which does not require a second message/signal to activate. In some other implementations, the configuration message defines the static allocation of uplink resources for contention-based uplink transmission and second signaling may be used to activate or to deactivate the allocation of uplink resources for contention-based uplink transmission.

At optional Step 2, the gNB 202 transmits control signaling to activate the configured CB-PUSCH resources (see optional messaging 208). In some implementations, the activation indication may be conveyed using PDCCH signaling. Additionally, the control signaling may also deactivate one or more previously activated CB-PUSCH resources.

At Step 3, the UE 204 determines to perform a contention-based uplink transmission, e.g., due to availability of data that is eligible for contention-based uplink transmission (see block 210).

At Step 4, the UE 204 selects a preamble for the contention-based uplink transmission and determines a corresponding PUSCH occasion (see block 212).

In some implementations, each UE 204 that is eligible for CB-PUSCH access and intends to initiate a contention-based uplink transmission may randomly select a preamble from a set of candidate sequences, such as Zadoff-Chu sequences, and transmits the selected preamble via the PRACH. In certain implementations, each preamble may be associated with a specific contention-based uplink transmission resource, referred to as a PUSCH occasion, which the UE 204 utilizes for transmitting uplink data, including higher-layer data (e.g., user data) and/or MAC-CEs.

In one implementation of the first solution, the mapping between preambles and PUSCH occasions may follow either a one-to-one (1:1) or a many-to-one (M:1) configuration. In the one-to-one mapping case, each preamble uniquely identifies a distinct CB-PUSCH resource. In the many-to-one mapping case, multiple preambles may correspond to the same PUSCH occasion, with each preamble potentially employing a distinct uplink reference signal (e.g., pilot sequence) to facilitate accurate channel estimation at the gNB 202, even in scenarios where preamble collisions occur. At the gNB 202, the receiver logic may be configured to first detect the transmitted preamble(s) and, based on the detected preambles, to attempt demodulation and decoding operations on the corresponding PUSCH occasions.

Different to the 2-step RACH procedure standardized for 5G NR, the preamble in the contention-based uplink transmission is not used for the computation of a timing advance (TA) at the base station (e.g., gNB 202). Rather, the preamble transmission is used for the identification of a contention-based uplink transmission, e.g., associated CB-PUSCH transmission linked to the preamble transmission. In some examples, a detected preamble may be used by the gNB 202 to address the UE 204 performing the contention-based uplink transmission in a response message, e.g., for cases when the CB-PUSCH transmission could not be correctly decoded, and thus the radio network temporary identifier (RNTI) of the transmitting UE 204 is unknown to the network (e.g., gNB 202).

Since computation of TA is not necessary for the contention-based uplink transmission, i.e., it is assumed that the UEs 204 initiating a contention-based uplink transmission is (already) uplink timing aligned, the preambles could be designed in a different way compared to the Zadoff-Chu sequences.

At Step 5, the UE 204 performs the contention-based uplink transmission, e.g., by transmitting the selected preamble and, in the same slot, transmitting uplink data on the corresponding CB-PUSCH resources (see messaging 214).

At Step 6, the gNB 202 detects the transmitted preamble and determines the corresponding PUSCH occasion in the same slot in which the preamble was received (see block 216).

At Step 7, the gNB 202 attempts to demodulate and decode the uplink data on the corresponding PUSCH occasion (see block 218). In certain implementations, the gNB 202 performs blind decoding of the uplink data.

In some implementations, CB-PUSCH contains an ID field, e.g., in a MAC-CE, identifying the UE 204 making the contention-based uplink transmission. In one example a C-RNTI MAC-CE is multiplexed in the CB-PUSCH. In another implementation the ID transmitted on the CG PUSCH resource may be different than the C-RNTI, e.g., the gNB 202 may assign UEs eligible for CB-PUSCH transmission a new CB ID for the purpose of identifying the user.

In some implementations, the size of the CB-PUSCH resources, e.g., number of RBs and position of RBs, are predefined or fixed. Similarly, the MCS and transport block (TB) size used for the uplink transmission on the CB-PUSCH resources may be predefined or fixed. In an alternative implementation of the embodiment, the preamble may implicitly indicate the MCS or TB size or CB-PUSCH resource information. Accordingly, the gNB 202 may attempts to decode a CB-PUSCH transmission based on the transmission parameters linked to an identified preamble.

At Step 8, the UE 204 monitors for feedback from the gNB 202 (see block 220). In some implementations, the UE 204 begins the monitoring a predetermined time after performing the contention-based uplink transmission.

At Step 9, the gNB 202 transmits feedback to the UE 204 based on detection and decoding of contention-based uplink signal (see messaging 222). For example, the feedback may indicate successful reception of the preamble and CB-PUSCH transmission (e.g., the uplink data) or may indicate successful reception of the preamble but unsuccessful decoding of the uplink data.

At optional Step 10, the UE 204 may determine to retransmit the preamble and CB-PUSCH transmission if feedback is not received from the gNB 202 within a certain time window (see messaging 224). In some implementations, the UE 204 selects a next occurring instance (e.g., occasion) of CB-PUSCH resources for the retransmission.

In some implementations, if the gNB 202 detects some energy on the CB-PUSCH resources (e.g., PUSCH detection) but cannot decode a PUSCH (e.g., because the cyclic redundancy check (CRC) failed), then the feedback message may contain a common (i.e., shared) indication that a collision happened and potentially include a back-off indicator. This feedback message may be broadcast/transmitted to multiple UEs, and the UE 204 monitoring for feedback after performing a contention-based uplink transmission may trigger autonomous retransmission of the preamble and CB-PUSCH, e.g., prior to expiry of a retransmission timer associated with the time window.

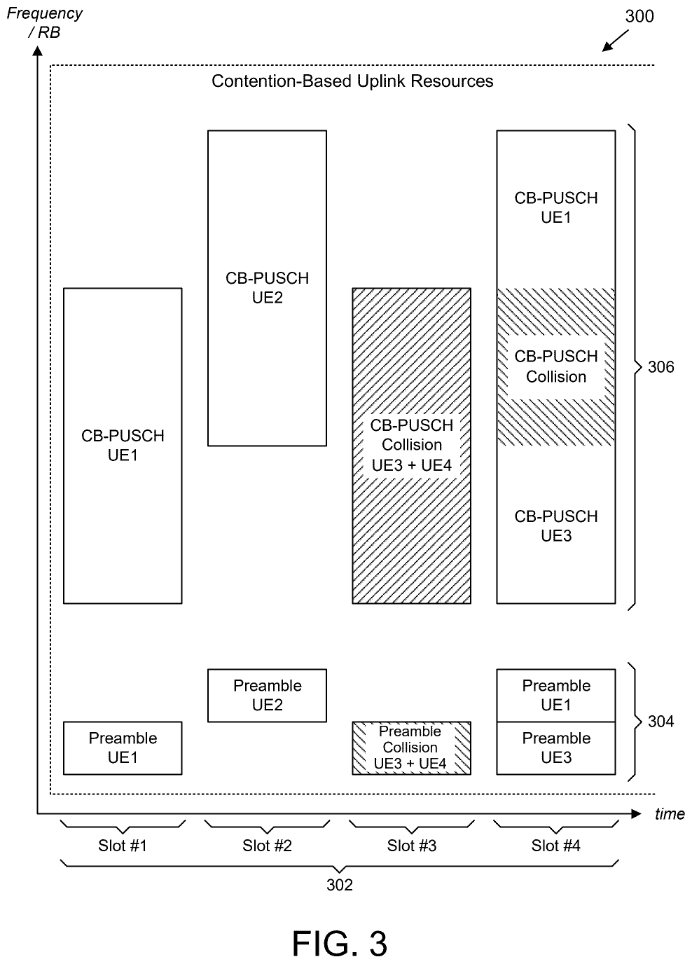

FIG. 3 illustrates an example of transmissions using a set of contention-based uplink resources 300, in accordance with aspects of the present disclosure. The set of contention-based uplink resources 300 includes a plurality of slots 302, each slot associated with a first subset of uplink resources 304 for preamble transmission, and a second subset of uplink resources 306 for CB-PUSCH transmission.

In some implementations, the first subset of uplink resources 304 may be referred to as preamble resources and the second subset of uplink resources 306 may be referred to as CB-PUSCH resources. In certain implementations, the first subset of uplink resources 304 are PRACH resources. While FIG. 3 illustrates FDM between the first subset of uplink resources 304 and the second subset of uplink resources 306, in other implementations different types of multiplexing may be used, including code division multiplexing (CDM), spatial division multiplexing (FDM), and the like.

In the depicted embodiment, a first UE (denoted “UE1”) transmits a preamble in slot 1, and also transmits a corresponding CB-PUSCH signal in the same slot. Additionally, a second UE (denoted “UE2”) transmits a second preamble in slot 2, and also transmits a corresponding CB-PUSCH signal in the same slot. As discussed above, each preamble may correspond to a CB-PUSCH resource and upon detecting a preamble, the network (e.g., gNB 202) attempts to decode the CB-PUSCH signal on the corresponding CB-PUSCH resource.

In some implementations, multiple UEs may select the same or overlapping resources for contention-based uplink transmission. In certain implementations, multiple UEs may select the same preamble or may select preambles that correspond to the same or overlapping PUSCH resources. In certain other implementations, the CB-PUSCH resources may be the same for all preambles. For example, the CB-PUSCH resources (i.e., for the uplink data part) may be fixed in order to simplify the CB-PUSCH decoding at the gNB 202.

In the depicted embodiment, a third UE (denoted “UE3”) and a fourth UE (denoted “UE4”) select the same preamble for transmission in slot 3. Accordingly, there is a preamble collision between UE3 and UE4 in slot 3, as well as a CB-PUSCH collision between UE3 and UE4. Additionally, the UE1 and UE3 may select different preambles for transmission in slot 4, but where the CB-PUSCH resources corresponding to the selected preamble are the same or overlapping. Consequently, there is a contention situation resulting in a CB-PUSCH collision between UE1 and UE3 in slot 4. Because of the collisions, the network (e.g., gNB 202) may not be able to decode the CB-PUSCH signals in slots 3 and 4.

Regarding the preamble selection, in some implementations, the UE 204 randomly selects a preamble from a predefined set of preambles. Alternatively, the UE 204 may be configured (e.g., by the gNB 202) with or configured set of preambles, from which the random selection is made.

In one implementation of the embodiment, a mapping is established between a preamble for contention-based uplink transmission (e.g., random access or PRACH preamble, or a different preamble sequence) and a corresponding PUSCH resource configuration. This mapping enables the preamble to implicitly signal decoding information to the gNB 202 (e.g., base station). For example, the PUSCH resource configuration may comprise transmission parameters, such as RB allocation, MCS, and TB size, for the CB-PUSCH transmission corresponding to the mapped preamble. In such implementations, upon reception of the preamble, the gNB 202 derives the associated PUSCH resource parameters without requiring explicit signaling of such parameters by the UE 204.

In some other implementations, when uplink data is available for transmission over contention-based PUSCH resources, the UE 204 selects a preamble based on the characteristics of the data to be transmitted. Specifically, the UE 204 may determine the most appropriate PUSCH resource configuration (i.e., the configuration that best accommodates the data in terms of MCS and TB size) from a predefined set of resource configurations. The UE 204 then selects the preamble associated with the chosen PUSCH configuration. In such implementations, upon reception of the preamble, the gNB 202 (e.g., base station) derives the associated PUSCH resource parameters without requiring explicit signaling of such parameters by the UE 204.

According to one embodiment, the network (e.g., gNB 202) configures whether an LCH is eligible for CB-PUSCH transmission. Similarly, the network may also configure whether a MAC-CE is eligible for contention-based uplink transmissions. In some implementations, a new LCH restriction is introduced which controls whether data of a LCH are allowed to be sent on contention-based uplink resources. The network configuration enables the scheduler of the gNB 202 to ensure that QoS requirements of LCHs are satisfied, e.g., LCH carrying data with strict QoS requirements may not be suitable for a contention-based uplink transmission and should be rather transmitted on dedicated uplink resources.

Regarding the feedback, in some implementations, the UE 204 monitors for a feedback response message from the network in response to a contention-based uplink transmission, e.g., comprising preamble and PUSCH transmissions. According to one implementation, the UE 204 monitors for PDCCH signaling during a predefined time window. In some examples, the predefined time window starts a predetermined offset from the slot where UE 204 performed the preamble and PUSCH transmissions, where the offset may be configured or fixed (e.g., by specification).

In various embodiments, the network (e.g., gNB 202) may detect a preamble for contention-based uplink transmission, but may be unable to correctly decode a CB-PUSCH transmission corresponding to the detected preamble. For example, a CB-PUSCH collision may result in the gNB 202 detecting the preamble and detecting energy on a corresponding CB-PSUCH resource, but being unable to decode the associated CB-PUSCH transmission. In such embodiments, the feedback message sent by the network may expressly or implicitly indicate the unsuccessful decoding.

In some implementations, the network (e.g., gNB) transmits DCI that allocates uplink resources for the (re)transmission of a TB originally sent via CB-PUSCH resources. In one implementation, the allocated resources are non-CB-PUSCH resources. In various embodiments, the network transmits the DCI in response to successfully detecting a preamble but failing to decode the associated CB-PUSCH transmission.

In some implementations, the DCI includes a field identifying the detected preamble. In one implementation, the field within the DCI explicitly identifies the successfully detected preamble, e.g., preamble ID is included in the DCI. For example, the DCI may be transmitted on the PDCCH and may be addressed to a common RNTI, such as a CB-PUSCH RNTI, which may be defined to support contention-based uplink transmission as described herein.

In certain implementations, the RNTI used to address the DCI is derived from a predefined formula that computes the RNTI based on the detected preamble transmission. In certain implementations, the RNTI may be based on the RACH resource used for the preamble transmission.

In some implementations, the DCI is configured to indicate a HARQ process ID to be used for the (re)transmission of the CB-PUSCH transmission on the allocated (e.g., dedicated) PUSCH resources. At this stage, the base station (e.g., gNB) may have failed to successfully decode the initial CB-PUSCH transmission and, as a result, may not have acquired the identity of the transmitting UE 204, i.e., its C-RNTI.

Due to the absence of UE identification, the HARQ process ID indicated by the DCI may inadvertently reference a HARQ process that is currently in use by the UE 204 for an unrelated uplink data transmission. In such cases, the UE 204, in accordance with the present embodiment, does not overwrite the content of the HARQ buffer associated with the ongoing uplink transmission. Instead, the UE 204 identifies an alternative HARQ process whose buffer is currently unoccupied or available for (re)transmission and maps the HARQ process ID indicated in the received DCI to the alternative ID of the selected available HARQ process.

In some implementations, this remapping operation is performed internally by the UE 204, thereby preserving the integrity of the ongoing transmission and avoiding buffer collisions. The UE 204 may maintain a mapping table or similar data structure to manage such remapping, ensuring consistent HARQ feedback timing and reliable retransmission behavior, despite the initial ambiguity in HARQ process allocation arising from the contention-based access procedure. In another example, the UE 204 keeps using the HARQ process ID used for the initial CB-PUSCH transmission.

In some implementations, a dedicated (e.g., reserved) HARQ process (and/or dedicated/reserved HARQ buffer) is used for a contention-based uplink transmission. Accordingly, the network (e.g., gNB) may assign certain HARQ processes for contention-based uplink transmission for UEs which are eligible for CB-PUSCH transmissions. In one example, the dedicated HARQ buffer may be a buffer similar to the MsgA/Msg3 buffer.

In various embodiments, the network (e.g., gNB 202) may detect a preamble for contention-based uplink transmission, and may successfully decode a CB-PUSCH transmission corresponding to the detected preamble. In such embodiments, the feedback message sent by the network may be a DCI message that expressly or implicitly indicates the successful decoding.

In some implementations, when the gNB 202 (e.g., base station) successfully decodes the preamble and the CB-PUSCH transmission, it becomes aware of the identity of the transmitting UE 204. This identification may be derived, for example, from a C-RNTI MAC-CE embedded within the CB-PUSCH transmission. In some implementations, the UE 204 considers a contention-based uplink transmission to be successfully completed upon reception of a DCI message addressed to the UE 204's C-RNTI, following the contention-based uplink transmission.

In some implementations, the DCI that serves as an acknowledgment of the successful reception of the CB-PUSCH may take the form of a UL grant addressed to the UE 204. In some implementations, the DCI may be received within a search space configured specifically for feedback to contention-based uplink transmissions.

Upon receipt of the acknowledgment DCI, the UE 204 may flush the HARQ buffer associated with the CB-PUSCH transmission. In order to distinguish the acknowledgment DCI (also referred to herein as a “confirmation” DCI) from “standard” DCIs (i.e., regular DCI unrelated to contention-based uplink transmission), a predefined HARQ process ID may be indicated within the confirmation DCI. Alternatively, the DCI may include a random-access preamble identifier (RAPID) corresponding to the originally transmitted PRACH preamble, thereby unambiguously linking the DCI to the CB-PUSCH transmission.

In another implementation, one or more specific fields within the DCI, or a combination thereof, may be set to predetermined values or codepoints to indicate the acknowledgment of the CB-PUSCH transmission. In yet another implementation, the acknowledgment of the successful CB-PUSCH decoding may be conveyed via a MAC-CE (e.g., an ACK MAC-CE) multiplexed within a downlink data transmission.

In various embodiments, the network (e.g., gNB 202) may detect energy on a resource for contention-based uplink transmission but be unable to decode the CB-PUSCH transmission and also unable to detect a preamble, e.g., due to CB-PUSCH collision. In such embodiments, the network is unable to determine a UE ID (or preamble ID) and thus the network does not transmit any feedback message.

In some implementations, the UE 204 re-transmits the preamble and CB-PUSCH after having not received either an acknowledgment for the successful reception of the CB-PUSCH transmission or a retransmission grant for the CB-PUSCH addressed to the CB-PUSCH RNTI during a predefined time window. In certain implementations, the retransmission of the preamble and/or the CB-PUSCH transmission may be performed with an increased transmit power compared to the previous transmission attempt.

In some implementations, the UE 204 maintains a counter which is increased for each contention-based uplink transmission attempt. In certain implementations, in response to the counter being equal to a predefined threshold the UE 204 halts the contention-based uplink transmission procedure. In certain implementations, the UE 204 considers the contention-based uplink transmission procedure as unsuccessfully completed upon reaching or exceeding a maximum defined number of transmission attempts.

In some implementations, upon an unsuccessfully completed contention-based uplink transmission, the UE 204 may transmit the uplink data of the CB-PUSCH using a “dedicated” PUSCH resource, e.g., a contention-free PUSCH resource allocated by dynamic grant (e.g., DCI) or configured grant PUSCH resource (e.g., a CG-PUSCH resource). To enable a retransmission of the CB-PUSCH data in a contention-free manner, the UE 204 may use the MAC SDUs which are contained in the CB-PUSCH as an input to the LCP procedure which is performed for a new UL grant corresponding to the contention-free PUSCH resource.

In one example, if the contention-free uplink grant size does not match the size of the TB stored in the buffer for the CB-PUSCH, then the UE 204 may indicate to the multiplexing and assembly entity to include the MAC subPDU(s) carrying MAC SDUs from the CB-PUSCH in the subsequent uplink transmission according to the UL grant.

In one example, the UE 204 may retrigger any MAC-CE(s)-if they are still pending and not canceled-which were included in the CB-PUSCH and includes those in the subsequent uplink transmission according to the UL grant.

In an alternative approach, the UE 204 may trigger an autonomous radio link control (RLC) retransmission of the MAC SDUs included in the CB-PUSCH to enable an inclusion of those MAC SDUs in a subsequent contention-free uplink transmission (e.g., scheduled by a dynamic UL grant or CG-PUSCH).

According to aspects of a second solution, a UE 104 may initiate a contention-based uplink transmission by transmitting using a new type of UL grant to facilitate contention-based uplink transmissions. This new type of uplink grant is introduced with the objective of reducing the overall latency associated with the conventional uplink scheduling procedures. In contrast to existing grant types-such as dynamic UL grants, where PUSCH resources are dynamically allocated via DCI (e.g., over PDCCH), and configured (e.g., semi-static) UL grants, where PUSCH resources are pre-configured through RRC signaling and optionally activated/deactivated via PDCCH-this second solution discloses a third category of UL grants.

In some implementations of the second solution, this third UL grant type enables contention-based access by assigning CB-PUSCH resources in a semi-static manner to one or more users (e.g., UEs 104). In certain implementations, these CB-PUSCH resources may be provisioned via RRC signaling, for example, through an RRC configuration message or system information broadcast. In one implementation, the NE 102 (e.g., base station, gNB) may assign configured grant uplink resources which are used for contention-based uplink transmission. In one example, the network indicates within a CG-config information element (IE) by means of a new IE, that the CG PUSCH resources are for the purpose of a contention-based uplink transmission procedure. These resources are to be utilized for contention-based uplink transmissions in a manner distinct from legacy CG-PUSCH procedures.

In certain implementations, a UE 104 which is eligible for contention-based uplink transmission (i.e., one that has been allocated CB-PUSCH resources by the network) may autonomously select one or more uplink transmission parameters associated with a CB-PUSCH transmission. For example, the parameters may include, but are not limited to: MCS, RB allocation size and location, RV, and the like.

In some implementations, in order to reduce the blind decoding complexity at the network-side and to ensure successful decoding of the CB-PUSCH transmission, the UE 104 may transmit to the NE 102 (e.g., base station, gNB) uplink control information (UCI) associated with the CB-PUSCH transmission, for example, via an out-of-band signaling mechanism.

In certain implementations, this UCI may include one or more of the following: MCS information (e.g., indicating the modulation and coding rate to facilitate decoding of the uplink transport block); a HARQ process ID (e.g., enabling identification and management of TBs and thereby HARQ retransmissions); an RV; RB allocation information (e.g., specifying the size and location of the assigned RBs); a UE ID (e.g., allowing the network to associate the CB-PUSCH transmission with a specific UE 104); or a combination thereof.

In one example, the UE ID may be a C-RNTI. Alternatively, the NE 102 (e.g., base station, gNB) may assign a dedicated ID during the CB-PUSCH resource configuration phase, and this dedicated ID may be signaled in the UCI. The latter approach provides the advantage of not exposing the C-RNTI in clear text, thereby offering enhanced security.

In some implementations, the UE 104 may select uplink transmission parameters from a predefined set of transmission configurations. In one example, the network configures a set of distinct uplink transmission parameter combinations (e.g., a combination of MCS levels and RB configurations) from which the UE 104 may autonomously select a single combination for use in a contention-based uplink transmission.

In some implementations, the UE 104 may select the uplink transmission parameters (e.g., modulation scheme, coding rate, TB size, RV, etc.) to meet the reliability and/or QoS requirements of the data which is multiplexed onto the CB-PUSCH resources. In one example, the UCI may include a parameter combination ID that indicates the selected uplink transmission parameter combination from the set of preconfigured uplink transmission parameter combinations.

In some implementations, the UE 104 autonomous selection of parameters may be constrained to within boundaries defined by the network, such that the network retains a level of control over the transmission characteristics and to ensure adherence to QoS requirements. In certain implementations, these constraints may be configured by the network and may limit, for example, the range of allowed MCS values, the size of the RB allocation, or specific RB positions within the uplink frequency spectrum.

In some implementations, the UE 104 is not required to transmit the contention-based PUSCH across the entire bandwidth allocated by the network for contention-based uplink transmissions. Instead, the UE 104 may utilize only a subset of the configured grant uplink resources for a given CB-PUSCH transmission. The allocation of these resources by the UE 104 is flexible, allowing dynamic selection of a portion of the pre-configured contention-based uplink bandwidth, thereby enabling more efficient resource utilization and reducing interference among multiple contending UEs 104.

In some implementations, to facilitate decoding at the NE 102 (e.g., base station, gNB) and to avoid an increased blind decoding, upon selecting transmission parameters for the contention-based uplink transmission, the UE 104 includes UCI indicating the selected transmission parameter in the CB-PUSCH transmission. In certain implementations, the NE 102 may detect the presence of UCI based on some CRC which is attached to the UCI.

In some implementations, the position of the UCI within the CB-PUSCH resources may be fixed. In certain implementations, the UCI may be positioned at the start of the CB-PUSCH resource, e.g., after an upfront demodulation reference signal (DM-RS) in order to allow for a fast detection of the UCI at the NE 102 side. In some implementations, the modulation scheme used for the transmission of the UCI may be predefined (e.g., configured or fixed in the specification). As an example, it may be predefined that quadrature phase shift keying (QPSK) is always used for contention-based uplink transmissions.

In some implementations, each UE 104 that is eligible for CB-PUSCH transmission (e.g., a UE 104 to which semi-static CB-PUSCH resources have been assigned) is allocated a corresponding UCI resource. By assigning distinct UCI resources to individual UEs 104, potential collisions of UCI transmissions among multiple UEs are effectively mitigated. Furthermore, the association of unique UCI resources with specific UEs 104 enables implicit identification of the transmitting UE 104, thereby obviating the need to include an explicit UE ID within either the UCI or the CB-PUSCH transmission itself.

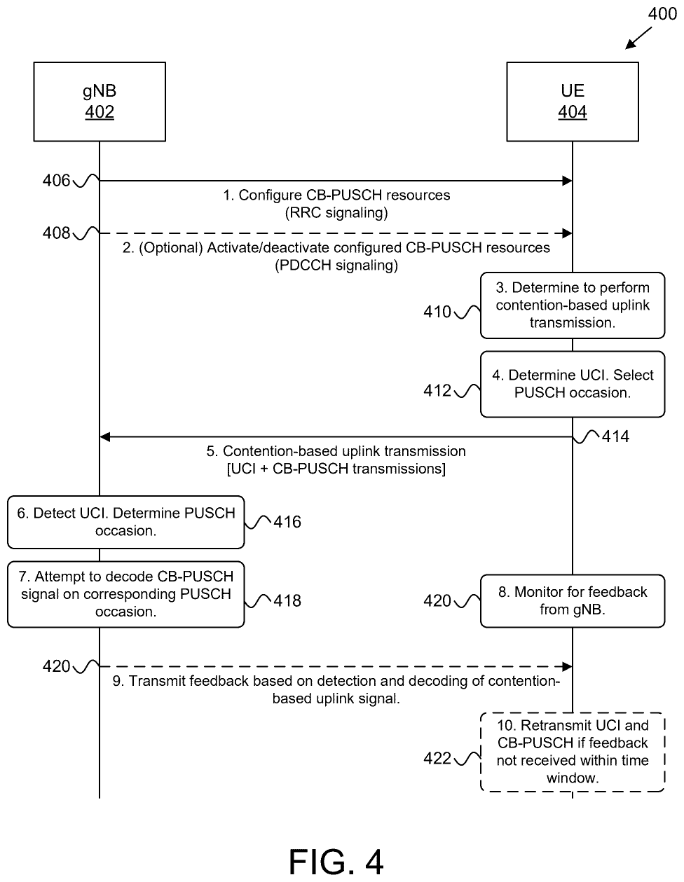

FIG. 4 illustrates an example of a procedure 400 for contention-based uplink transmission on a set of uplink resources, in accordance with aspects of the present disclosure. The procedure 400 may implement or be implemented by aspects of the wireless communication system 100. For example, the procedure 400 may include a gNB 402 and at least one UE 404. The gNB 402 may implement or be implemented by an NE 102, and the UE(s) 404 may implement or be implemented by one or more UEs 104 as described herein.

At Step 1, the gNB 402 configures the one or more UEs 404 with CB-PUSCH resources, e.g., by sending a configuration message for contention-based uplink transmission (see messaging 406). In some implementations, the configuration message may be conveyed using RRC signaling.

At optional Step 2, the gNB 402 transmits control signaling to activate the configured CB-PUSCH resources (see optional messaging 408). In some implementations, the activation indication may be conveyed using PDCCH signaling. Additionally, the control signaling may also deactivate one or more previously activated CB-PUSCH resources.

At Step 3, the UE 404 determines to perform a contention-based uplink transmission, e.g., due to availability of data that is eligible for contention-based uplink transmission (see block 410).

At Step 4, the UE 404 determines UCI for the contention-based uplink transmission (see block 412). Additionally, the UE 404 may select a PUSCH occasion for the contention-based uplink transmission. In cases where the UE 404 is allocated a UCI resource, the PUSCH occasion may be selected based on the UCI resource.

At Step 5, the UE 404 performs the contention-based uplink transmission, e.g., by transmitting the UCI and, in the same slot, transmitting uplink data on the selected CB-PUSCH resources (see messaging 414). In some implementations, UCI contains an ID field identifying the UE 404 making the contention-based uplink transmission. In one example, a C-RNTI of the UE 404 is multiplexed in the UCI CB-PUSCH.

At Step 6, the gNB 402 detects the transmitted UCI and determines a corresponding PUSCH occasion in the same slot in which the UCI was received (see block 416).

At Step 7, the gNB 402 attempts to demodulate and decode the uplink data on the corresponding PUSCH occasion (see block 418). In certain implementations, the gNB 402 uses the UCI to reduce the complexity of the blind decoding of the uplink data.

In some implementations, the UE 404 may multiplex a C-RNTI MAC-CE in a TB transmitted on CB-PUSCH resources in order to enable the gNB 402 to identify the UE 404 performing the contention-based uplink transmission. However, in case the UCI already includes some information identifying the UE 404, the C-RNTI MAC-CE may be omitted as redundant in view of the UCI.

At Step 8, the UE 404 monitors for feedback from the gNB 402 (see block 420). In some implementations, the UE 404 begins the monitoring a predetermined time after performing the contention-based uplink transmission.

At Step 9, the gNB 402 transmits feedback to the UE 404 based on detection and decoding of contention-based uplink signal (see messaging 422). For example, the feedback may indicate successful reception of the UCI and CB-PUSCH transmission (e.g., the uplink data) or may indicate successful reception of the UCI but unsuccessful decoding of the uplink data.

At optional Step 10, the UE 404 may determine to retransmit the UCI and CB-PUSCH transmission if feedback is not received from the gNB 402 within a certain time window (see messaging 414). In some implementations, the UE 404 selects a next occurring instance (e.g., occasion) of CB-PUSCH resources for the retransmission.

In some implementations, if the gNB 402 detects some energy on the CB-PUSCH resources (e.g., PUSCH detection) but cannot decode a PUSCH (e.g., CRC failed), then the feedback message may contain a common (i.e., shared) indication that a collision happened and potentially include a back-off indicator. This feedback message may be broadcast/transmitted to multiple UEs, and the UE 404 monitoring for feedback after performing a contention-based uplink transmission may trigger autonomous retransmission of the UCI and CB-PUSCH, e.g., prior to expiry of a retransmission timer associated with the time window.

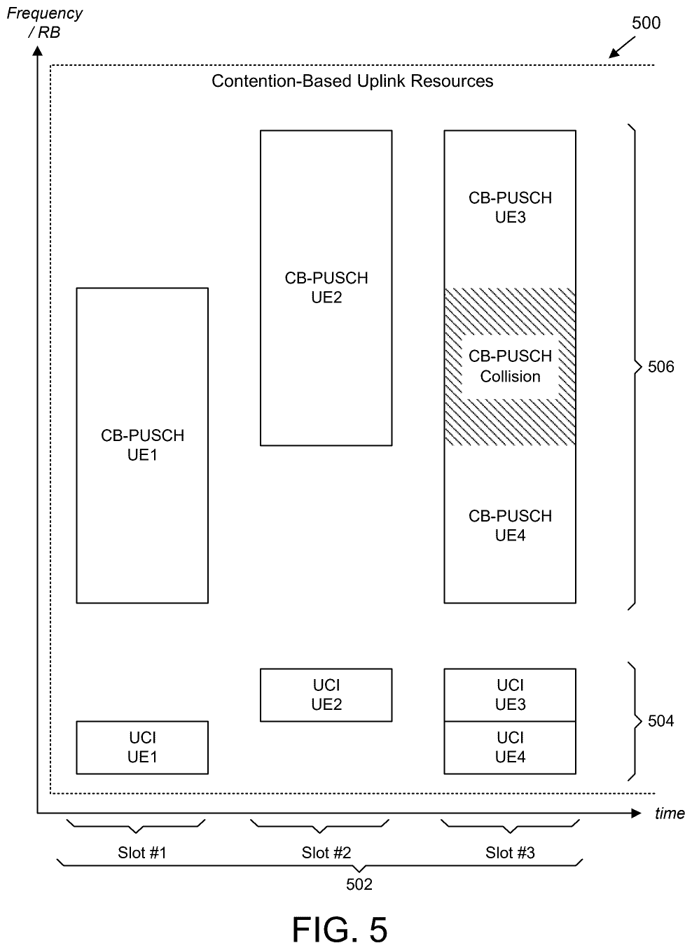

FIG. 5 illustrates an example of transmissions using a set of contention-based uplink resources 500, in accordance with aspects of the present disclosure. The set of contention-based uplink resources 500 includes a plurality of slots 502, each slot associated with a first subset of uplink resources 504 for UCI transmission, and a second subset of uplink resources 506 for CB-PUSCH transmission.

In some implementations, the first subset of uplink resources 504 may be referred to as UCI resources and the second subset of uplink resources 506 may be referred to as CB-PUSCH resources. While FIG. 5 illustrates FDM between the first subset of uplink resources 504 and the second subset of uplink resources 506, in other implementations different types of multiplexing may be used, including code division multiplexing (CDM), spatial division multiplexing (FDM), and the like.

In the depicted embodiment, a first UE (denoted “UE1”) transmits UCI in slot 1, and also transmits a corresponding CB-PUSCH signal in the same slot. Additionally, a second UE (denoted “UE2”) transmits a second UCI in slot 2, and also transmits a corresponding CB-PUSCH signal in the same slot. As discussed above, the network (e.g., gNB 402) detects the UCI, and uses the decoded UCI to reduce the blind decoding complexity of a CB-PUSCH signal on the corresponding CB-PUSCH resource.

In some implementations, multiple UEs may select the same or overlapping resources for contention-based uplink transmission. In certain implementations, multiple UEs may select the same UCI resource or may select UCI resources that correspond to the same or overlapping PUSCH resources. In certain other implementations, the CB-PUSCH resources may be the same for all UCI resources. For example, the CB-PUSCH resources (i.e., for the uplink data part) may be fixed in order to simplify the CB-PUSCH decoding at the gNB 402.

In the depicted embodiment, a third UE (denoted “UE3”) and a fourth UE (denoted “UE4”) may select different UCI resources for transmission in slot 3, but may select CB-PUSCH resources that are the same or overlapping. Consequently, there is a contention situation resulting in a CB-PUSCH collision between UE3 and UE4 in slot 3. Because of the collisions, the network (e.g., gNB 402) cannot decode the CB-PUSCH signals in slot 3.

In some implementations, a UE 404 that has been configured for contention-based uplink transmission may additionally provide assistance information to the network (e.g., gNB 402) regarding future usage of CB-PUSCH resources. In one implementation, the assistance information may comprise an indication identifying one or more future CB-PUSCH resources that the UE 404 does not intend to utilize. The UE 404 may derive such information based on current uplink data buffer status and/or predictive algorithms, including artificial intelligence (AI) or machine learning (ML) techniques, for forecasting future uplink data arrival and resource demand.

In certain implementations, the UE 404 may notify the gNB 402 that it will refrain from utilizing CB-PUSCH resources for a specified duration (e.g., the next x milliseconds). This assistance information can be advantageously employed by the gNB 402 to enhance detection of CB-PUSCH transmissions and to facilitate more efficient allocation or reassignment of CB-PUSCH resources to other UEs.

Regarding the feedback, in some implementations, the UE 404 monitors for a feedback response message from the network in response to a contention-based uplink transmission, e.g., comprising UCI and PUSCH transmissions. According to one implementation, the UE 404 monitors for PDCCH signaling during a predefined time window. In some examples, the predefined time window starts a predetermined offset from the slot where the UE 404 performed the UCI and CB-PUSCH transmissions, where the offset may be configured or fixed (e.g., by specification).

In various embodiments, the network (e.g., gNB 402) may detect a preamble for contention-based uplink transmission, but may be unable to correctly decode a CB-PUSCH transmission corresponding to the detected UCI. For example, a CB-PUSCH collision may result in a gNB 402 detecting the UCI and detecting energy on a corresponding CB-PSUCH resource, but being unable to decode the associated CB-PUSCH transmission. In such embodiments, the feedback message sent by the network may expressly or implicitly indicate the unsuccessful decoding.

In one embodiment, the network (e.g., gNB 402) transmits DCI that allocates uplink resources for the (re)transmission of a TB originally sent via the CB-PUSCH resources. In one implementation, the allocated resources are non-CB-PUSCH resources. In various embodiments, the network transmits the DCI in response to successfully detecting UCI of a UE 404 but failing to decode the associated CB-PUSCH transmission.

In some implementations, the DCI includes a field identifying the detected UCI. In one implementation, the field within the DCI is set to the ID sent in the UCI. In one example, the DCI may be transmitted on the PDCCH and may be addressed to a common RNTI, such as a CB-PUSCH RNTI, which may be defined to support contention-based uplink transmission as described herein.

In certain implementations, the RNTI used to address the DCI is derived from a predefined formula that computes the RNTI based on the detected preamble transmission. In certain implementations, the RNTI may be based on the UCI resource used for the UCI transmission.

In the case that the ID sent within the UCI is the C-RNTI of the UE 404 or based on the mapping between the C-RNTI and the ID sent within the UCI, the PDCCH allocating resources for the retransmission of a CB-PUSCH transmission may be addressed to the C-RNTI of the UE 404 that made the contention-based uplink transmission, e.g., there is no need for some explicit ID field within the DCI/PDCCH to identify the UE 404 associated with the detected UCI.

In some implementations, the DCI may be configured to indicate a HARQ process ID to be used for the (re)transmission of the CB-PUSCH transmission on the allocated (e.g., dedicated) PUSCH resources. In certain implementations, the HARQ process of the UL grant DCI is set to the HARQ process ID sent within the UCI. In other alternative implementations, the HARQ process of the UL grant DCI is set to a predefined HARQ process ID.

In some implementations, the combination of UE ID (e.g., either ID field in the DCI or the C-RNTI used for masking the CRC of the DCI) and the HARQ process ID and the new data indicator (NDI) field set to a predefined value may be used to identify a retransmission UL grant for the uplink data of the CB-PUSCH transmission. In one example, the NDI value may be set to ‘1’ indicates a retransmission grant, whereas an NDI set to ‘0’ indicates the successful reception of the CB-PUSCH transmission. Here, the actual value of the NDI is set for signaling, whereas with conventional uplink grants (e.g., contention-free uplink grants, such as dynamic uplink grants or configured uplink grants) the UE 404 checks whether the current NDI value is toggled (i.e., changed) with respect to a previous NDI value, such that the toggled or non-toggled state conveys whether the grant is for retransmission or new data.

In various embodiments, the network (e.g., gNB 402) may detect UCI for contention-based uplink transmission, and may successfully decode a CB-PUSCH transmission corresponding to the detected UCI. In such embodiments, the feedback message sent by the network may be a DCI message that expressly or implicitly indicates the successful decoding.

In some implementations, when the gNB 402 (e.g., base station) successfully decodes the UCI and the CB-PUSCH transmission, it becomes aware of the identity of the transmitting UE 404. This identification may be derived, for example, from a C-RNTI MAC-CE embedded within the CB-PUSCH transmission, or from C-RNTI or other ID included in the UCI. In some implementations, the UE 404 may consider a contention-based uplink transmission to be successfully completed upon reception of a DCI message addressed to the UE 404's C-RNTI, following a contention-based uplink transmission.

In some implementations, the DCI that serves as an acknowledgment of the successful reception of the CB-PUSCH may take the form of a UL grant addressed to the UE 404. In an exemplary case, this DCI may be received within a search space configured specifically for contention-based uplink transmissions.

Upon receipt of the acknowledgment DCI, the UE 404 may flush the HARQ buffer associated with the CB-PUSCH transmission. In order to distinguish the “confirmation” DCI from “standard” DCIs, the HARQ process of the UL grant DCI may be set to the same HARQ process ID included in the UCI. In certain implementations, the combination of UE ID, C-RNTI used for masking the CRC of the DCI, and the NDI field may be set to a predefined value to identify a retransmission UL grant for a CB-PUSCH transmission. In one example, the NDI set to ‘0’ indicates the successful reception of the CB-PUSCH transmission.

In another implementation, one or more specific fields within the DCI, or a combination thereof, may be set to predetermined values or codepoints to indicate the acknowledgment of the CB-PUSCH transmission. In yet another implementation, acknowledgment of the successful CB-PUSCH decoding may be conveyed via a MAC-CE (e.g., an acknowledgement (ACK) MAC-CE) multiplexed within a downlink data transmission addressed to the C-RNTI.

In various embodiments, the network (e.g., gNB 402) may detect energy on a resource for contention-based uplink transmission but be unable to decode the CB-PUSCH transmission and also unable to detect a UE ID, e.g., due to collision of the CB-PUSCH and/or UCI. In such embodiments, the network does not transmit any feedback message.

In some implementations, the UE 404 re-transmits the UCI and CB-PUSCH after having not received either an acknowledgment for the successful reception of the CB-PUSCH transmission or a retransmission grant for the CB-PUSCH addressed to the CB-PUSCH RNTI/C-RNTI during a predefined time window. In certain implementations, the retransmission of the UCI and/or the CB-PUSCH transmission may be performed with an increased transmit power compared to the previous transmission attempt.

In some implementations, the UE 404 maintains a counter which is increased for each contention-based uplink transmission attempt. In certain implementations, in response to the counter being equal to a predefined threshold the UE 404 halts the contention-based uplink transmission procedure. In certain implementations, the UE 404 considers the contention-based uplink transmission procedure as unsuccessfully completed upon reaching or exceeding a maximum defined number of transmission attempts.

In various embodiments, the network (e.g., gNB 402) may explicitly enable or disable contention-based uplink transmissions through control signaling. In one implementation, the network may signal whether CB-PUSCH resources and/or associated random access preamble transmissions are activated or deactivated.

In an exemplary implementation, the activation or deactivation of configured CB-PUSCH resources is communicated via MAC-CE signaling and/or DCI. In one specific example, the signaling related to activation or deactivation is conveyed in a group-common message, such as a PDCCH transmission that either directly includes the activation or deactivation information, or that schedules a physical downlink shared channel (PDSCH) transmission carrying the MAC-CE. The PDCCH may be addressed to a group-common RNTI.

Beneficially, the activation/deactivation mechanism enables the network to dynamically manage the availability of CB-PUSCH resources, for example, based on real-time system requirements or current cell load conditions. Such dynamic control contributes to efficient utilization of radio resources and enhanced overall network performance.

In some implementations, a prioritization scheme may be employed for handling multiple types of uplink grants. In certain implementations, when a UE 404 is allocated PUSCH resources via a PDCCH transmission (commonly referred to as a dynamic uplink grant), the UE 404 may refrain from initiating any contention-based uplink transmission during overlapping time intervals (e.g., slots or subframes).

In some implementations, dynamic uplink grants may be assigned a higher priority relative to contention-based uplink transmissions. Similarly, in the case where a UE 404 has been configured with a configured grant CG for PUSCH transmission (CG-PUSCH transmission), such configured uplink grants are likewise prioritized over contention-based uplink transmissions.

In some implementations, the priority of different UL grant types may be

determined at least based on the content of the data for transmission, whether this is data that has been multiplexed in an UL grant (retransmission case) or newly available data that can be multiplexed in a UL grant (initial transmission case).

In some implementations, the prioritization is done at least based on the priority of the data, e.g., highest priority among priorities of the logical channels that are multiplexed (i.e., the MAC PDU to transmit is already stored in the HARQ buffer) or have data available that can be multiplexed (i.e., the MAC PDU to transmit is not stored in the HARQ buffer) in the MAC PDU, according to the LCH mapping restrictions.

In some implementations, the priority of an UL grant is based both on the type of UL grant (e.g., contention-free uplink grant or contention-based UL grant) and the priority of the data that has been or can be multiplexed on the UL grant.

In some implementations, the UE 404 may be allowed to perform a contention-based uplink transmission only for cases where the UE 404 is uplink timing synchronized. In one example, the UE 404 is only allowed to perform a contention-based uplink transmission when the timing alignment timer (TAT) is running and is not allowed to perform a contention-based uplink transmission when the TAT is not running. The TAT is used to manage uplink timing synchronization and is started (or restarted) when the UE 404 receives a TA command; if the UE 404 does not receive a new TA command before expiry of the TAT, then it assumed it has lost uplink timing synchronization.

In some implementations, user data and control data that are eligible for transmission on contention-based uplink resources, such as CB-PUSCH resources, may be excluded from consideration in buffer status reporting. In one implementation, when generating a BSR, the UE 404 may omit (i.e., ignore) data associated with LCHs that are permitted to utilize CB-PUSCH resources when generating a BSR.

This exclusion is intended to prevent the network (e.g., gNB 402) from over-allocating contention-free uplink transmission resources, under the assumption that such data would otherwise be included in the BSR and require dedicated scheduling. Accordingly, when the network has activated or allocated CB-PUSCH resources, the UE 404 does not report data intended for transmission on such contention-based uplink resources in the BSR.

In alternative implementations, the UE 404 may be configured to report the data associated with LCHs eligible for contention-based uplink transmission separately in the BSR. This enables the network (e.g., gNB 402) to distinguish between data that requires contention-free uplink transmission and data that can be transmitted using contention-based mechanisms. Beneficially, such differentiation enhances the network's ability to perform efficient and appropriate resource allocation.

In some implementations, for LCP procedures triggered by a dynamic UL grant or a CG PUSCH transmission, the UE 404 may be configured to exclude LCHs that are eligible for contention-based uplink transmission, provided that CB-PUSCH resources have been allocated or activated by the network. To ensure that data intended for contention-based uplink transmission is not transmitted over dynamically allocated or configured grant resources, an additional LCH restriction may be introduced. This restriction mechanism ensures separation of data across contention-based and contention-free uplink transmissions and prevents unnecessary utilization of scheduled PUSCH resources for data that can be transmitted via CB-PUSCH. Alternatively, for LCP procedures triggered by a CG PUSCH transmission, the UE 404 may multiplex data of LCHs that are eligible for contention-based uplink transmission if there is remaining space after including data intended for contention-free uplink transmission.

In some implementations, the UE 404 does not cancel a triggered BSR if a BSR MAC-CE has been transmitted on a CB-PUSCH resource and the corresponding contention-based uplink transmission has not been successfully completed. In other words, the BSR remains triggered until feedback is received that indicates successful reception of the CB-PUSCH resource containing the BSR MAC-CE.

In certain implementations, in order to increase the reliability of a BSR procedure, the UE 404 (e.g., at the MAC entity) may also send a BSR MAC-CE on a contention-free PUSCH, e.g., dynamic UL grant or configured uplink grant, even if that BSR MAC-CE has been already included in a CB-PUSCH transmission which has not been yet successfully completed. In one example, the UE 404 (e.g., MAC entity) only cancels a triggered BSR in that case that the BSR MAC-CE was successfully transmitted on a CB-PUSCH resource, e.g., the contention-based uplink procedure has been successfully completed.

In some implementations, UE 404 may be configured to prioritize a contention-free uplink transmission over a contention-based uplink transmission under specific timing conditions. In particular, if the UE 404 has uplink data available for transmission that qualifies for both contention-free physical uplink shared channel (CF-PUSCH) and CB-PUSCH resources, and CB-PUSCH resources are available at a first time instance (denoted as T₀) while CF-PUSCH resources (e.g., resources allocated via a dynamic uplink grant or configured grant (CG)) are available at a second time instance (denoted as T₁), then the UE 404 selects the contention-free PUSCH resources for transmission if the time difference (i.e., T₁−T₀) does not exceed a predefined threshold.

In other words, when a UE 404 has uplink data ready for transmission, and it can choose between CB-PUSCH (i.e., where resources are shared among a group of UEs 104) and CF-PUSCH (i.e., where dedicated resources are assigned directly via dynamic uplink grant or configured uplink grant), then the UE 404 should prioritize the CF-PUSCH if the CF-PUSCH resource timing (T1) is not later than a certain predefined time interval from the CB-PUSCH.

In certain implementations, the predefined threshold may be configured by the network (e.g., gNB 402) and signaled to the UE 404, for example, in units of milliseconds or slot durations. By adhering to this rule, the UE 404 ensures preferential use of contention-free uplink resources, thereby improving transmission reliability and reducing uplink collisions, provided that the associated delay relative to contention-based uplink transmission is within acceptable limits.

In some implementations, uplink data of a LCH or radio bearer may be transmitted either by CB-PUSCH transmission or CF-PUSCH transmission depending on the delay status of the data. According to one implementation, the decision on whether to use CF-PUSCH or CB-PUSCH resources for the data of a LCH depends on an amount of remaining time of the data (e.g., PDU or SDU). If the remaining time of a data packet is less than a predefined threshold—or if the data is delay-critical data, then the UE 404 sends the data over CB-PUSCH resource in order to ensure a timely delivery. Assuming that the congestion rate of CB-PUSCH are well managed by the network, CB-PUSCH transmissions are advantageous over CF-PUSCH transmissions in terms of latency, as there is no need to wait for a UL grant in response to a SR/BSR transmission. In such implementations, the decision of UL access, e.g., using CF-PUSCH or CB-PUSCH resources, is determined on a packet level.

In some implementations, uplink data associated with a LCH or radio bearer may be transmitted using either a CB-PUSCH transmission or a CF-PUSCH transmission, based on a delay condition associated with the data. In particular, the selection of the uplink transmission mode (e.g., using CF-PUSCH or CB-PUSCH resources) may be determined dynamically at a packet level, taking into account a remaining time metric corresponding to the latency budget of a given data unit, such as a PDU or SDU.

In one implementation, the UE 404 evaluates the remaining time of a data packet relative to a predefined delay threshold. If the remaining time falls below the threshold, e.g., also referred to as delay-critical data, the UE 404 selects the CB-PUSCH transmission mode to expedite uplink delivery. This approach leverages the inherent advantage of CB-PUSCH in reducing transmission latency, as such transmissions can occur without requiring a SR/BSR transmission and/or reception of an explicit UL grant from the network.

It is assumed that the network maintains an acceptable congestion level for CB-PUSCH resources, thereby ensuring a reliable contention-based access mechanism. As such, latency-sensitive data can be transmitted with minimized delay, while data with relaxed timing requirements may utilize CF-PUSCH resources for more efficient resource utilization. Beneficially, by enabling packet-level selection between CB-PUSCH and CF-PUSCH transmission modes based on the time-sensitivity of a data unit, some flexible and efficient uplink transmission strategy is provided.

In some implementations, when a BSR has been triggered and no valid contention-free UL-SCH resources (e.g., dynamic UL grant) are available for transmission, the UE 404 performs a check to determine whether CB-PUSCH resources are available to carry the BSR. If CB-PUSCH resources are available, then the UE 404 transmits the BSR using the available CB-PUSCH resources. If no such resources are available, the UE 404 initiates a SR procedure in order to request uplink resources from the network.

In this context, the definition of “valid UL-SCH resources” should be extended to include not only dynamically scheduled UL-SCH resources (e.g., those granted via uplink grants in response to SR or BSR) but also CB-PUSCH resources that are available for uplink transmissions without requiring prior scheduling. This expanded definition ensures that the UE 404 can opportunistically utilize CB-PUSCH resources for urgent control signaling, such as BSR, thereby reducing signaling latency and improving uplink responsiveness under resource-constrained conditions.

In some implementations, a UE 404 may be configured to transmit UE status information via CB-PUSCH resources to reduce uplink scheduling latency. In one specific implementation, the UE 404 transmits buffer status information and/or delay status information over contention-based uplink resources to provide uplink scheduling assistance information to the gNB 402 (e.g., base station) in an expedited manner.

In contrast to conventional procedures in which the UE 404 first transmits a SR on a physical uplink control channel (PUCCH) resource, or initiates a random access procedure to obtain uplink resources for transmitting buffer status and/or delay status information, in some implementations the UE 404 may directly transmit a BSR MAC-CE and/or DSR MAC-CE on contention-based uplink resources.

In one example implementation, the UE 404 may be configured to transmit only certain types of BSRs via contention-based uplink resources. For instance, the UE 404 may transmit only a regular BSR, such as one triggered by the arrival of high-priority, newly generated data, using contention-based uplink resources. In contrast, periodic BSR transmissions may continue to be performed using conventional uplink scheduling procedures, e.g., by utilizing dynamically allocated uplink resources obtained in response to an SR or random access procedure.

Beneficially, the delay between the availability of delay-sensitive data and the scheduling of corresponding uplink transmission resources may be minimized by employing contention-based uplink resources in this manner. Consequently, the UE 404 may restrict the use of contention-based uplink access to the transmission of delay-critical status or assistance information, such as BSRs and/or DSRs. By limiting contention-based uplink transmissions to such information, the probability of collision among UEs 104 is maintained at a low level.

In another implementation, the UE 404 may transmit measurement reports, such as radio resource management (RRM) measurements and/or layer 1 or layer 2 (L1/L2) measurements (e.g., channel state information (CSI)), via contention-based uplink resources.

According to aspects of a third solution, a UE 104 may initiate a contention-based uplink transmission that utilizes one or more network assigned uplink transmission parameters. For example, the UE 104 may be configured to use allocated CG PUSCH resources and the allocated MCS. In some implementations, the UE 104 may be configured to insert padding in case there is not sufficient uplink data eligible for contention-based uplink transmission, i.e., to meet a network-configured RB size.

In some implementations, the UE 104 may be configured to insert an in-band UE identification (e.g., UE ID) in header, such as C-RNTI MAC-CE. In some implementations, the UE 104 may be configured to transmit UCI with every contention-based uplink transmission, e.g., to support soft combining at the gNB 402 (e.g., base station).

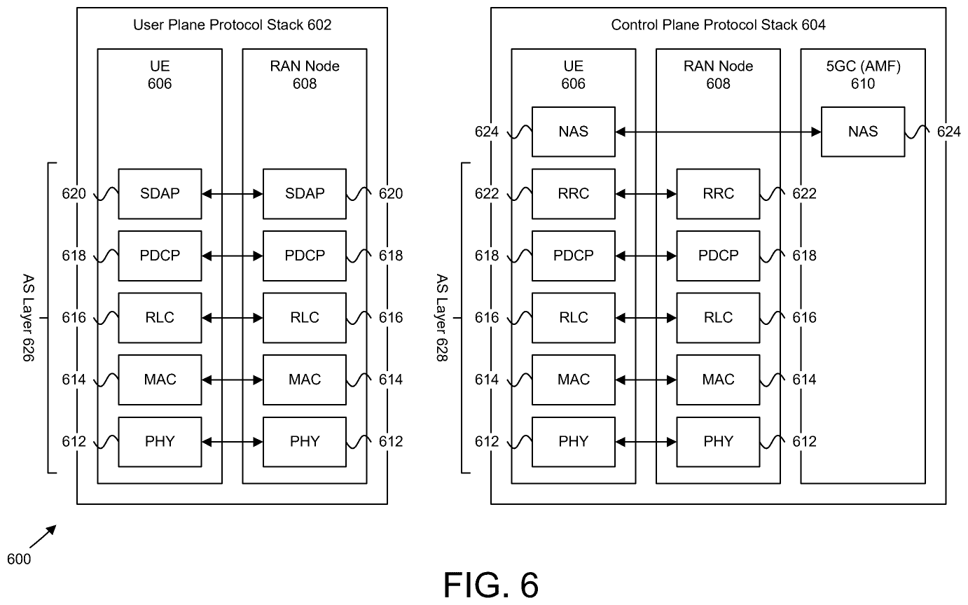

FIG. 6 illustrates an example of a protocol stack 600, in accordance with aspects of the present disclosure. While FIG. 6 shows a UE 606, a RAN node 608, and a 5GC 610 (e.g., comprising at least an AMF), these are representative of a set of UEs 104 interacting with an NE 102 (e.g., base station) and a CN 106. As depicted, the protocol stack 600 comprises a user plane protocol stack 602 and a control plane protocol stack 604. The user plane protocol stack 602 includes a physical (PHY) layer 612, a MAC sublayer 614, a RLC sublayer 616, a packet data convergence protocol (PDCP) sublayer 618, and a service data adaptation protocol (SDAP) sublayer 620. The control plane protocol stack 604 includes a PHY layer 612, a MAC sublayer 614, an RLC sublayer 616, and a PDCP sublayer 618. The control plane protocol stack 604 also includes a RRC layer 622 and a non-access stratum (NAS) layer 624.

The AS layer 626 (also referred to as “AS protocol stack”) for the user plane protocol stack 602 consists of at least the SDAP sublayer 620, the PDCP sublayer 618, the RLC sublayer 616, the MAC sublayer 614, and the PHY layer 612. The AS layer 628 for the control plane protocol stack 604 consists of at least the RRC layer 622, the PDCP sublayer 618, the RLC sublayer 616, the MAC sublayer 614, and the PHY layer 612. The layer-1 (L1) includes the PHY layer 612. The layer-2 (L2) is split into the SDAP sublayer 620, PDCP sublayer 618, RLC sublayer 616, and MAC sublayer 614. The layer-3 (L3) includes the RRC layer 622 and the NAS layer 624 for the control plane and includes, e.g., an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 612 offers transport channels to the MAC sublayer 614. The PHY layer 612 may perform a beam failure detection procedure using energy detection thresholds, as described herein. In certain embodiments, the PHY layer 612 may send an indication of beam failure to a MAC entity at the MAC sublayer 614. The MAC sublayer 614 offers logical channels (LCHs) to the RLC sublayer 616. The RLC sublayer 616 offers RLC channels to the PDCP sublayer 618.

The PDCP sublayer 618 offers radio bearers to the SDAP sublayer 620 and/or RRC layer 622. The SDAP sublayer 620 offers QoS flows to the core network (e.g., 5GC). The RRC layer 622 provides for the addition, modification, and release of carrier aggregation (CA) and/or dual connectivity. The RRC layer 622 also manages the establishment, configuration, maintenance, and release of signaling radio bearers (SRBs) and data radio bearers (DRBs).

The NAS layer 624 is between the UE 606 and an AMF in the 5GC 610. NAS messages are passed transparently through the RAN. The NAS layer 624 is used to manage the establishment of communication sessions and for maintaining continuous communications with the UE 606 as it moves between different cells of the RAN. In contrast, the AS layers 626 and 628 are between the UE 606 and the RAN (i.e., RAN node 608) and carry information over the wireless portion of the network. While not depicted in FIG. 6, the IP layer exists above the NAS layer 624, a transport layer exists above the IP layer, and an application layer exists above the transport layer.

The MAC sublayer 614 is the lowest sublayer in the L2 architecture of the NR protocol stack. Its connection to the PHY layer 612 below is through transport channels, and the connection to the RLC sublayer 616 above is through LCHs. The MAC sublayer 614 therefore performs multiplexing and demultiplexing between LCHs and transport channels: the MAC sublayer 614 in the transmitting side constructs MAC PDUs (also known as transport blocks (TBs)) from MAC service data units (SDUs) received through LCHs, and the MAC sublayer 614 in the receiving side recovers MAC SDUs from MAC PDUs received through transport channels.

The MAC sublayer 614 provides a data transfer service for the RLC sublayer 616 through LCHs, which are either control LCHs which carry control data (e.g., RRC signaling) or traffic LCHs which carry user plane data. On the other hand, the data from the MAC sublayer 614 is exchanged with the PHY layer 612 through transport channels, which are classified as UL or DL. Data is multiplexed into transport channels depending on how it is transmitted over the air.

The PHY layer 612 is responsible for the actual transmission of data and control information via the air interface, i.e., the PHY layer 612 carries all information from the MAC transport channels over the air interface on the transmission side. Some of the important functions performed by the PHY layer 612 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 622. The PHY layer 612 performs transmissions based on transmission parameters, such as the modulation scheme, the coding rate (i.e., the modulation and coding scheme (MCS)), the number of physical resource blocks (PRBs), etc.

In some embodiments, the protocol stack 600 may be an NR protocol stack used in a 5G NR system. An LTE protocol stack comprises similar structure to the protocol stack 600, with the differences that the LTE protocol stack lacks the SDAP sublayer 620 in the AS layer 626, that an EPC replaces the 5GC 610, and that the NAS layer 624 is between the UE 606 and an MME in the EPC. Also, the present disclosure distinguishes between a protocol layer (such as the aforementioned PHY layer 612, MAC sublayer 614, RLC sublayer 616, PDCP sublayer 618, SDAP sublayer 620, RRC layer 622 and NAS layer 624) and a transmission layer in multiple-input multiple-output (MIMO) communication (also referred to as a “MIMO layer” or a “data stream”).

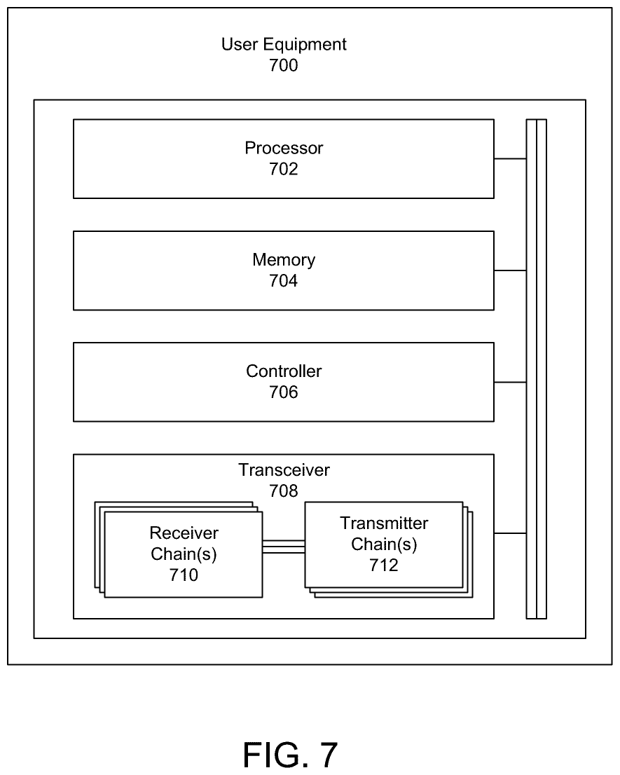

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field programmable gate array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions that, when executed by the processor 702, cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform various functions (e.g., operations, signaling) described herein (e.g., executing, by the processor 702, instructions stored in the memory 704). In some implementations, the processor 702 may include multiple processors and the memory 704 may include multiple memories. One or more of the multiple processors may be coupled with one or more of the multiple memories, which may be individually or collectively, configured to perform various functions (e.g., operations, signaling) of the UE 700 as described herein.

The processor 702 coupled with the memory 704 may be configured to, capable of, or operable to cause the UE 700 to receive a resource allocation comprising a plurality of sets of uplink resources for contention-based uplink transmission; and perform a contention-based uplink transmission on one of the plurality of sets of uplink resources based at least in part on a condition for the contention-based uplink transmission being satisfied, wherein the contention-based uplink transmission comprises a first uplink signal and a second uplink signal transmitted on a same time resource.

In some implementations, the condition for the contention-based uplink transmission being satisfied comprises data being available for transmission or in a buffer of the UE 700, and wherein the processor 702 coupled with the memory 704 may be configured to, capable of, or operable to cause the UE 700 to select a parameter for the contention-based uplink transmission based at least in part on data being available for transmission, the data associated with one or more LCHs that are eligible for contention-based uplink transmission.

In certain implementations, the processor 702 coupled with the memory 704 may be configured to, capable of, or operable to cause the UE 700 to receive a LCH configuration message that indicates whether a respective LCH is eligible for contention-based uplink transmission.

In certain implementations, the first uplink signal comprises UCI that indicates the selected parameter, and wherein the selected parameter comprises one or more of a MCS value, a RB allocation size and RB location, or a RV associated with the second uplink signal.

In some implementations, the processor 702 coupled with the memory 704 may be configured to, capable of, or operable to cause the UE 700 to autonomously select a preamble from a set of candidate preambles, each candidate preamble comprising a sequence associated with a respective set from the plurality of sets of uplink resources, and wherein the first uplink signal comprises a preamble transmission based at least in part on the selected preamble.

In some implementations, the second uplink signal is a PUSCH transmission, and wherein the second uplink signal includes a UE identifier (UE ID) that identifies the UE 700 associated with the contention-based uplink transmission.

In some implementations, the second uplink signal comprises a BSR (e.g., BSR MAC-CE), and wherein the feedback comprises a second resource allocation for communication user data based on the BSR. In some implementations, the second uplink signal comprises a DSR (e.g., DSR MAC-CE), and wherein the feedback comprises a second resource allocation for communication user data based on the DSR.

In certain implementations, the feedback comprises a DCI message or a MAC-CE multiplexed with a downlink data transmission. In certain implementations, the feedback comprises an identifier that identifies a preamble, a UE (e.g., UE ID of the UE 700), or a HARQ process associated with the contention-based uplink transmission.

In certain implementations, the feedback indicates successful reception of the second uplink signal of the contention-based uplink transmission or includes an uplink grant for retransmission of the second uplink signal of the contention-based uplink transmission.

In some implementations, the processor 702 coupled with the memory 704 may be configured to, capable of, or operable to cause the UE 700 to: A) monitor for feedback in response to the contention-based uplink transmission; and B) re-transmit the contention-based uplink transmission when the feedback is not received during a predefined time window.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

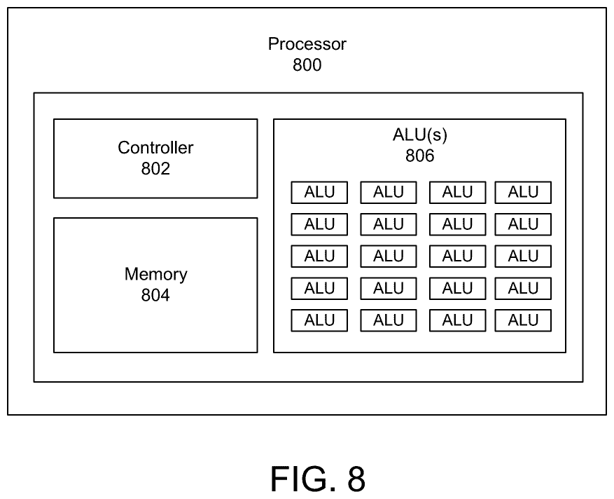

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1, or L2, or L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein.

Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

In some implementations, the processor 800 may support various functions (e.g., operations, signaling) of a UE, in accordance with examples as disclosed herein. For example, the controller 802 coupled with the memory 804 may be configured to, capable of, or operable to cause the processor 800 to receive a resource allocation comprising a plurality of sets of uplink resources for contention-based uplink transmission; and perform a contention-based uplink transmission on one of the plurality of sets of uplink resources based at least in part on a condition for the contention-based uplink transmission being satisfied, wherein the contention-based uplink transmission comprises a first uplink signal and a second uplink signal transmitted on a same time resource. Moreover, the controller 802 coupled with the memory 804 may be configured to, capable of, or operable to cause the processor 800 to perform one or more functions (e.g., operations, signaling) of the UE as described herein.

In certain implementations, the processor 800 may support various functions (e.g., operations, signaling) of a base station (e.g., NE 102, gNB 202, gNB 402 or RAN node 608), in accordance with examples as disclosed herein. For example, the controller 802 coupled with the memory 804 may be configured to, capable of, or operable to cause the processor 800 to transmit a resource allocation comprising a plurality of sets of uplink resources for contention-based uplink transmissions; receive a contention-based uplink transmission on one of the plurality of sets of uplink resources, where the contention-based uplink transmission comprises a first uplink signal and a second uplink signal received in a same time resource; and transmit a feedback based on whether the second uplink signal of the contention-based uplink transmission is successfully decoded. Moreover, the controller 802 coupled with the memory 804 may be configured to, capable of, or operable to cause the processor 800 to perform one or more functions (e.g., operations, signaling) of the base station as described herein.

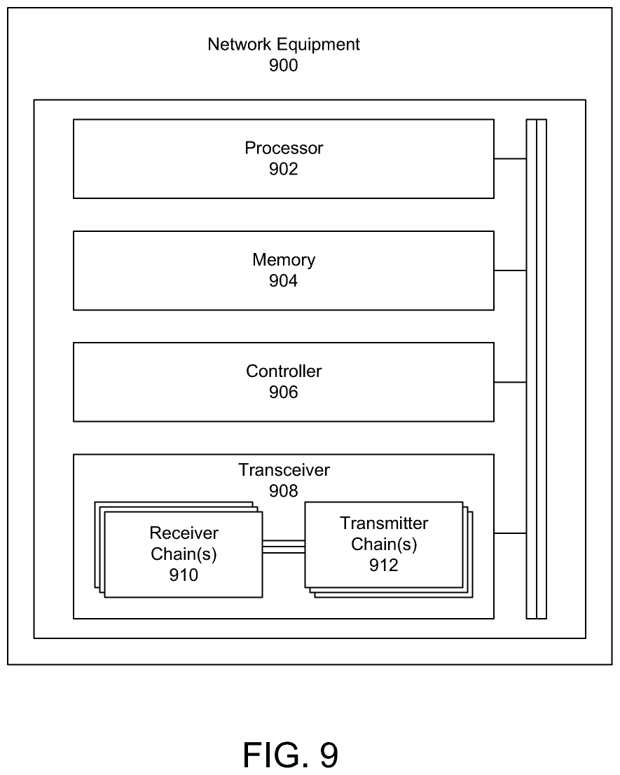

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform various functions (e.g., operations, signaling) described herein (e.g., executing, by the processor 902, instructions stored in the memory 904). In some implementations, the processor 902 may include multiple processors and the memory 904 may include multiple memories. One or more of the multiple processors may be coupled with one or more of the multiple memories, which may be individually or collectively, configured to perform various functions (e.g., operations, signaling) of the NE 900 as described herein.

The processor 902 coupled with the memory 904 may be configured to, capable of, or operable to cause the NE 900 to transmit a resource allocation comprising a plurality of sets of uplink resources for contention-based uplink transmissions; receive a contention-based uplink transmission on one of the plurality of sets of uplink resources, where the contention-based uplink transmission comprises a first uplink signal and a second uplink signal received in a same time resource; and transmit a feedback based on whether the second uplink signal of the contention-based uplink transmission is successfully decoded.

In some implementations, the processor 902 coupled with the memory 904 may be configured to, capable of, or operable to cause the NE 900 to: A) detect the first uplink signal; B) determine a PUSCH occasion that corresponds to the detected first uplink signal; and C) perform a demodulation and decoding operation on the second uplink signal in the corresponding PUSCH occasion, where the feedback is based on the demodulation and decoding operation. For example, the feedback may indicate whether the second uplink signal was successfully decoded. As another example, the feedback may grant additional uplink resources for transmission of new data based on the contents of the decoded second uplink signal.

In some implementations, the processor 902 coupled with the memory 904 may be configured to, capable of, or operable to cause the NE 900 to: A) receive a reservation signal prior to the contention-based uplink transmission; and B) monitor for the contention-based uplink transmission based on the reservation signal.

In some implementations, the first uplink signal comprises UCI that indicates a parameter, the parameter comprising one or more of a MCS value, an RB allocation size and RB location, a RV associated with the second uplink signal, or a combination thereof.

In some implementations, the first uplink signal comprises a preamble selected from a set of candidate preambles. In such implementations, each candidate preamble may comprise a sequence (e.g., a Zadoff-Chu sequence) associated with a respective set of uplink resources (e.g., a set of CB-PUSCH resources) from the plurality of sets of uplink resources. In certain implementations, the feedback comprises an identifier indicating the preamble. For example, the presence of the preamble ID in the feedback may confirm to the UE that the first uplink signal was successfully received by the NE 900.

In some implementations, the second uplink signal is a PUSCH transmission (e.g., CB-PUSCH transmission) that includes a UE ID that identifies the UE associated with the contention-based uplink transmission. For example, the presence of the UE ID in the feedback may confirm to the UE that the second uplink signal was successfully received (and decoded) by the NE 900.

In certain implementations, the feedback indicates successful reception of the second uplink signal of the contention-based uplink transmission or includes an uplink grant for retransmission of the second uplink signal of the contention-based uplink transmission.

In certain implementations, the feedback comprises a DCI message or a MAC-CE multiplexed with a downlink data transmission. In certain implementations, the feedback comprises an identifier that identifies a preamble, a UE, or a HARQ process associated with the contention-based uplink transmission.

In some implementations, the second uplink signal comprises a BSR (e.g., BSR MAC-CE), and wherein the feedback comprises a second resource allocation for communication user data based on the BSR. In some implementations, the second uplink signal comprises a DSR (e.g., DSR MAC-CE), and wherein the feedback comprises a second resource allocation for communication user data based on the DSR.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

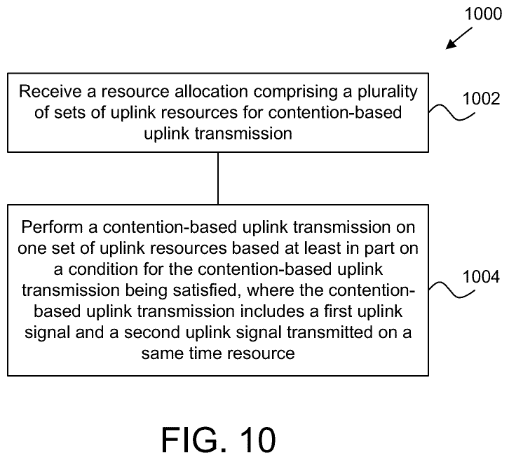

FIG. 10 illustrates a flowchart of a method 1000 in accordance with aspects of the present disclosure. The operations of the method 1000 may be implemented by a UE as described herein. In some implementations, the UE may execute a set of instructions to control the function elements of the UE to perform the described functions.

At step 1002, the method 1000 may include receiving a resource allocation comprising a plurality of sets of uplink resources for contention-based uplink transmission. The operations of step 1002 may be performed in accordance with examples as described herein. In some implementations, aspects of the operations of step 1002 may be performed by a UE, as described with reference to FIG. 7.

At step 1004, the method 1000 may include performing a contention-based uplink transmission on one of the plurality of sets of uplink resources based at least in part on a condition for the contention-based uplink transmission being satisfied, where the contention-based uplink transmission comprises a first uplink signal and a second uplink signal transmitted in a same time resource. The operations of step 1004 may be performed in accordance with examples as described herein. In some implementations, aspects of the operations of step 1004 may be performed by a UE, as described with reference to FIG. 7.

It should be noted that the method 1000 described herein describes one possible implementation, and that the operations and the steps may be rearranged or otherwise modified and that other implementations are possible.

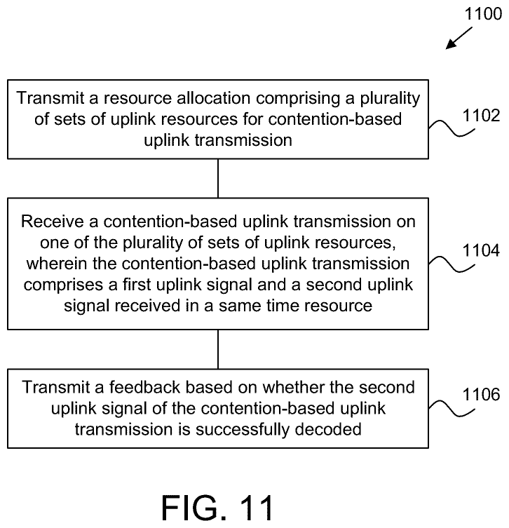

FIG. 11 illustrates a flowchart of a method 1100 in accordance with aspects of the present disclosure. The operations of the method 1100 may be implemented by a base station, such as an NE as described herein. In some implementations, the base station may execute a set of instructions to control the function elements of the base station to perform the described functions.

At step 1102, the method 1100 may include transmitting a resource allocation comprising a plurality of sets of uplink resources for contention-based uplink transmissions. The operations of step 1102 may be performed in accordance with examples as described herein. In some implementations, aspects of the operations of step 1102 may be performed by a NE, as described with reference to FIG. 9.

At step 1104, the method 1100 may include receiving a contention-based uplink transmission on one of the plurality of sets of uplink resources, where the contention-based uplink transmission comprises a first uplink signal and a second uplink signal received in a same time resource. The operations of step 1104 may be performed in accordance with examples as described herein. In some implementations, aspects of the operations of step 1104 may be performed by a NE, as described with reference to FIG. 9.

At step 1106, the method 1100 may include transmitting a feedback based on whether the second uplink signal of the contention-based uplink transmission is successfully decoded. The operations of step 1106 may be performed in accordance with examples as described herein. In some implementations, aspects of the operations of step 1106 may be performed by a NE, as described with reference to FIG. 9.

It should be noted that the method 1100 described herein describes one possible implementation, and that the operations and the steps may be rearranged or otherwise modified and that other implementations are possible.

What is claimed is:

1. A user equipment (UE) for wireless communication, comprising:
at least one memory; and
at least one processor coupled with the at least one memory and configured to cause the UE to:
receive a resource allocation comprising a plurality of sets of uplink resources for contention-based uplink transmission; and
perform a contention-based uplink transmission on one of the plurality of sets of uplink resources based at least in part on a condition for the contention-based uplink transmission being satisfied, wherein the contention-based uplink transmission comprises a first uplink signal and a second uplink signal transmitted on a same time resource.

2. The UE of claim 1, wherein the condition for the contention-based uplink transmission being satisfied comprises data being available for transmission or in a buffer of the UE, and wherein the at least one processor is configured to cause the UE to:
select a parameter for the contention-based uplink transmission based at least in part on data being available for transmission, the data associated with one or more logical channels (LCHs) that are eligible for contention-based uplink transmission.

3. The UE of claim 2, wherein the at least one processor is configured to cause the UE to receive a LCH configuration message that indicates whether a respective LCH is eligible for contention-based uplink transmission.

4. The UE of claim 2, wherein the first uplink signal comprises uplink control information (UCI) that indicates the selected parameter, and wherein the selected parameter comprises one or more of a modulation and coding scheme (MCS) value, a resource block (RB) allocation size and RB location, or a redundancy version (RV) associated with the second uplink signal.

5. The UE of claim 1, wherein the at least one processor is configured to cause the UE to autonomously select a preamble from a set of candidate preambles, each candidate preamble comprising a sequence associated with a respective set from the plurality of sets of uplink resources, and wherein the first uplink signal comprises a preamble transmission based at least in part on the selected preamble.

6. The UE of claim 1, wherein the second uplink signal is a physical uplink shared channel (PUSCH) transmission, and wherein the second uplink signal includes a UE identifier that identifies the UE associated with the contention-based uplink transmission.

7. The UE of claim 1, wherein the at least one processor is configured to cause the UE to:
monitor for feedback in response to the contention-based uplink transmission; and
re-transmit the contention-based uplink transmission when the feedback is not received during a predefined time window.

8. The UE of claim 7, wherein the feedback comprises a downlink control information (DCI) message or a medium access control (MAC) control element (CE) multiplexed with a downlink data transmission.

9. The UE of claim 7, wherein the feedback comprises an identifier that identifies a preamble, a UE, or a hybrid automatic repeat request (HARQ) process associated with the contention-based uplink transmission.

10. The UE of claim 7, wherein the feedback comprises an uplink grant that allocates uplink resources for retransmission of the second uplink signal.

11. The UE of claim 7, wherein the feedback indicates successful reception of the second uplink signal of the contention-based uplink transmission or includes an uplink grant for retransmission of the second uplink signal of the contention-based uplink transmission.

12. A method performed by a user equipment (UE), the method comprising:
receiving a resource allocation comprising a plurality of sets of uplink resources for contention-based uplink transmission; and
performing a contention-based uplink transmission on one of the plurality of sets of uplink resources based at least in part on a condition for the contention-based uplink transmission being satisfied, wherein the contention-based uplink transmission comprises a first uplink signal and a second uplink signal transmitted in a same time resource.

13. A base station for wireless communication, comprising:
at least one memory; and
at least one processor coupled with the at least one memory and configured to cause the base station to:
transmit a resource allocation comprising a plurality of sets of uplink resources for contention-based uplink transmission;
receive a contention-based uplink transmission on one of the plurality of sets of uplink resources, wherein the contention-based uplink transmission comprises a first uplink signal and a second uplink signal received in a same time resource; and
transmit a feedback based on whether the second uplink signal of the contention-based uplink transmission is successfully decoded.

14. The base station of claim 13, wherein the at least one processor is configured to cause the base station to:
detect the first uplink signal;
determine a physical uplink shared channel (PUSCH) occasion that corresponds to the detected first uplink signal; and
perform a demodulation and decoding operation on the corresponding PUSCH occasion, wherein the feedback is based on the demodulation and decoding operation.

15. The base station of claim 13, wherein the at least one processor is configured to cause the base station to:
receive a reservation signal prior to the contention-based uplink transmission; and
monitor for the contention-based uplink transmission based on the reservation signal.

16. The base station of claim 13, wherein the first uplink signal comprises uplink control information (UCI) that indicates a parameter, the parameter comprising one or more of a modulation and coding scheme (MCS) value, a resource block (RB) allocation size and RB location, or a redundancy version (RV) associated with the second uplink signal.

17. The base station of claim 13, wherein the first uplink signal comprises a preamble selected from a set of candidate preambles, each candidate preamble comprising a sequence associated with a respective set from the plurality of sets of uplink resources, and wherein the feedback comprises an identifier indicating the preamble.

18. The base station of claim 13, wherein the second uplink signal is a physical uplink shared channel (PUSCH) transmission, wherein the second uplink signal comprises a user equipment (UE) identifier that identifies a UE associated with the contention-based uplink transmission, wherein the feedback indicates successful reception of the second uplink signal of the contention-based uplink transmission or includes an uplink grant for retransmission of the second uplink signal of the contention-based uplink transmission.

19. The base station of claim 13, wherein the second uplink signal comprises a buffer status report (BSR), and wherein the feedback comprises a second resource allocation for communication user data based on the BSR.

20. A method performed by a base station, the method comprising:
transmitting a resource allocation comprising a plurality of sets of uplink resources for contention-based uplink transmissions;
receiving a contention-based uplink transmission on one of the plurality of sets of uplink resources, wherein the contention-based uplink transmission comprises a first uplink signal and a second uplink signal received in a same time resource; and
transmitting a feedback based on whether the second uplink signal of the contention-based uplink transmission is successfully decoded.
